(19) United States
(12) Patent Application Publication
(10) Pub. No.: US 2017/0316383 A1
(43) Pub. Date: Nov. 2, 2017

(54) Meeting Setup System and Method

(71) Applicant: ShoreTel, Inc., Sunnyvale, CA (US)

(72) Inventors: Venkatraman Naganathan, San Jose, CA (US); Charles Zilm, Hartsdale, NY (US); Pankaj Malhotra, Sunnyvale, CA (US); Prabjeet Singh, Fremont, CA (US)

(21) Appl. No.: 15/141,037

(22) Filed: Apr. 28, 2016

(51) Int. Cl. G06Q 10/10; H04L 29/06

(52) U.S. Cl. CPC G06Q 10/1095; H04L 67/42

(57) ABSTRACT

A meeting request is received that specifies a first participant account and a proposed topic for a meeting. A database is traversed to determine one or more second participant accounts for the meeting that are linked to the proposed topic. The meeting is scheduled with the first participant account and the one or more second participant accounts. The database contains data for a plurality of accounts (including the first participant account and the one or more second participant account) associated with entities, a plurality of events involving the entities, a plurality of prior topics derived from the events, and a plurality of links between the accounts, events and prior topics.

### BACKGROUND

In a typical enterprise environment, when a person (meeting organizer) attempts to setup a meeting with other people on a certain topic, the meeting organizer determines a list of participants and a context for the meeting, then invokes a calendar application and fills in optional and mandatory participants (based on the people the meeting organizer believes are interested in this topic), time slots to meet (based on the people's calendars showing availability), meeting rooms (based on calendar availability and meeting room artifacts, such as capacity, the presence of a computer/projector, etc.), a conference bridge (if needed) for the meeting and some basic context such as a topic summary and documents to be discussed. This process is manual, painful and error prone and contributes to loss in productivity.

Some meeting setup systems attempt to solve some of the meeting setup problems, primarily by assisting with scheduling the meeting after the meeting organizer has selected the participants. For example, one solution will suggest available conference rooms once the meeting organizer inputs a time slot. Additionally, another solution enables a meeting organizer to enter time slots and allows the other meeting participants to vote on the time slots. Another meeting setup solution creates a virtual secretary that appears to interact with the participants via email messages to schedule the meeting. Together with a lot of human inputs to these solutions, a suitable schedule for a meeting is eventually determined.

### SUMMARY

Some embodiments involve a method comprising: receiving, by one or more computers through one or more data channels from a first client device associated with a first participant account, a meeting request that specifies the first participant account and a proposed topic for a meeting; determining, by the one or more computers reading and traversing a database in a data storage system, one or more second participant accounts for the meeting that are linked to the proposed topic in the database; and scheduling, by the one or more computers, the meeting with the first participant account and the one or more second participant accounts by transmitting meeting invites through the one or more data channels to the first client device and one or more second client devices associated with the one or more second participant accounts; and wherein: the database contains data for a plurality of accounts associated with entities, a plurality of events involving the entities, a plurality of prior topics derived from the events, and a plurality of links between the accounts, events and prior topics; and the meeting request activates the reading and traversing of the database by the one or more computers to determine the one or more second participant accounts; and wherein the plurality of accounts includes the first participant account and the one or more second participant account.

Some embodiments involve a computing system, comprising one or more processors and an electronic memory. The electronic memory comprises computer-executable instructions that, when executed by the one or more processors, cause the at one or more processors to perform acts including: receiving, by the one or more processors through one or more data channels from a first client device associated with a first participant account, a meeting request that specifies the first participant account and a proposed topic for a meeting; determining, by the one or more processors reading and traversing a database in a data storage system, one or more second participant accounts for the meeting that are linked to the proposed topic in the database; and scheduling, by the one or more processors, the meeting with the first participant account and the one or more second participant accounts by transmitting meeting invites through the one or more data channels to the first client device and one or more second client devices associated with the one or more second participant accounts; and wherein: the database contains data for a plurality of accounts associated with entities, a plurality of events involving the entities, a plurality of prior topics derived from the events, and a plurality of links between the accounts, events and prior topics; and the meeting request activates the reading and traversing of the database by the one or more processors to determine the one or more second participant accounts; and wherein the plurality of accounts includes the first participant account and the one or more second participant account.

Some embodiments involve a non-transitory computer-readable medium comprising instructions stored thereon that, when executed on one or more computers, perform the steps of: receiving, by the one or more computers through one or more data channels from a first client device associated with a first participant account, a meeting request that specifies the first participant account and a proposed topic for a meeting; determining, by the one or more computers reading and traversing a database in a data storage system, one or more second participant accounts for the meeting that are linked to the proposed topic in the database; and scheduling, by the one or more computers, the meeting with the first participant account and the one or more second participant accounts by transmitting meeting invites through the one or more data channels to the first client device and one or more second client devices associated with the one or more second participant accounts; and wherein: the database contains data for a plurality of accounts associated with entities, a plurality of events involving the entities, a plurality of prior topics derived from the events, and a plurality of links between the accounts, events and prior topics; and the meeting request activates the reading and traversing of the database by the one or more computers to determine the one or more second participant accounts; and wherein the plurality of accounts includes the first participant account and the one or more second participant account.

In some embodiments, the database is a graph database having account vertices for the plurality of accounts, event vertices for the plurality of events, topic vertices for the plurality of prior topics, topic edges linking the topic vertices to the event vertices, and non-topic edges linking the account vertices to the event vertices; the reading and traversing of the database further comprises reading a first account vertex for the first participant account, traversing from the first account vertex through a first non-topic edge to a first event vertex, traversing from the first event vertex through a first topic edge to a first topic vertex, and traversing from the first event vertex through a second non-topic edge to a second account vertex for a first one of the one or more second participant accounts; and the one or more computers or processors determine whether the first one of the one or more second participant accounts is linked to the proposed topic by comparing a first prior topic of the first topic vertex to the proposed topic.

In some embodiments, the one or more computers or processors determine, by reading and traversing the database in the data storage system, a relevance of a subset of the plurality of accounts to the proposed topic; and the determining of the one or more second participant accounts further comprises selecting, by the one or more computers or processors, the one or more second participant accounts from the subset of the plurality of accounts.

In some embodiments, the one or more computers or processors determine, by reading and traversing the database in the data storage system, a rank of the relevance of the accounts in the subset of the plurality of accounts to the proposed topic; and the determining of the one or more second participant accounts further comprises selecting, by the one or more computers or processors, the one or more second participant accounts from the subset of the plurality of accounts in accordance with their rank.

In some embodiments, the determining of the rank further comprises determining how recently and how actively the accounts in the subset of the plurality of accounts have been involved with the proposed topic.

In some embodiments, the one or more computers or processors determine, by reading and traversing the database in the data storage system, one or more documents for the meeting that are linked to the proposed topic in the database.

In some embodiments, prior to transmitting meeting invites, the one or more computers or processors transmit a proposed schedule for the meeting to the first client device for presentation to a meeting organizer to approve or change the proposed schedule.

In some embodiments, the one or more computers or processors collect prior email data and prior meeting data; and the one or more computers or processors form the database in the data storage system from the prior email data and the prior meeting data.

In some embodiments, the forming of the database further comprises extracting the prior topics from the prior email data and the prior meeting data.

### BRIEF DESCRIPTION OF THE DRAWINGS

FIG. 1 shows a simplified diagram of an example interconnection environment for use with some embodiments.

FIG. 2 shows a simplified diagram of example levels for a hierarchy of data types for use with some embodiments.

FIG. 3 shows a simplified graphical representation of a graph database for use with some embodiments.

FIG. 4 shows a simplified schematic diagram of an example meeting setup system in accordance with some embodiments.

FIG. 5 shows a simplified flowchart for an example data collection process performed by the meeting setup system shown in FIG. 4, in accordance with some embodiments.

FIG. 6 shows a simplified flowchart for an example topic extraction process performed by a database interface system of the meeting setup system shown in FIG. 4, in accordance with one or more example embodiments.

FIG. 7 shows a simplified flowchart for an example meeting setup process performed by the database interface system, in accordance with one or more example embodiments.

FIG. 8 shows a simplified flowchart for example process to determine relevant accounts for the meeting setup process shown in FIG. 7, in accordance with one or more example embodiments.

FIG. 9 shows a simplified flowchart for another example process to determine relevant accounts for the meeting setup process shown in FIG. 7, in accordance with one or more example embodiments.

FIG. 10 shows a simplified flowchart for an example process to determine relevant documents for the meeting setup process shown in FIG. 7, in accordance with one or more example embodiments.

FIG. 11 shows a simplified schematic diagram of a computerized system for use in the example meeting setup system shown in FIG. 4, in accordance with an embodiment of the present invention.

### DETAILED DESCRIPTION

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

Embodiments of an improved system and technique for setting up a meeting between people with a minimum of human interaction or interference are disclosed herein. The system operates with numerous people and businesses (various entities and associated items) that generally communicate with each other regarding various activities in which they are involved together. As a result of their communications with each other, the entities are considered to form an “interconnection environment.” Employees who work together within a business enterprise, business associates within different enterprises involved in joint projects, homeowners in a neighborhood association, and close friends and family groups are examples of people who regularly communicate with each other on various topics or subjects of mutual concern. Such communication is typically done by email, chat, short message service (SMS) text messaging, social networking, phone, voicemail, in-person, etc. Also, some people maintain blogs, web sites or wiki pages through which they address such topics or subjects. Some of these communication techniques leave an electronic trail of data indicative of the entities involved in the communication, the subjects discussed, and other relevant information. Different communication techniques result (either directly or indirectly) in automatic recording of different types of information regarding the entities and subjects. Email communications, for example, directly leave a detailed record of the parties involved in the communication and the text of the discussion in a storage system of an email server. Blogs directly leave a record of the blog owner, frequent commenters, and the text of the blog post. Phone conversations, on the other hand, generally leave only a record of the parties to a phone call in a storage subsystem of a telephone system, without any topic or context. However, the parties and subject of a conference call or an in-person meeting may be indirectly recorded in a calendar application maintained by any one of the participants.

Regardless of the level of detail of such records, a considerable amount of information is eventually collected by a variety of different systems that potentially link numerous entities in relation to their mutual concerns, interests, projects or other topics. The present meeting setup system and technique gathers this information from a variety of different sources and analyzes it to extract, classify and store data regarding relationships and linkages between different entities and between entities and topics. Then, in some embodiments, when a person (i.e., a meeting organizer, an initial/first meeting participant, or a perspective account) wants to set up a conference or meeting to discuss a subject or project, the meeting organizer merely enters the desired meeting topic into the meeting setup system; and the meeting setup system automatically sorts through the stored data related to the desired topic to determine who the other participants of the meeting should be (as well as other details of the meeting as described below) and to schedule the meeting with all of the participants, with minimal intervention by the initial participant. The meeting setup system and technique, thus, generates or schedules a meeting based on a received topic, rather than on a received list of participants, in contrast to conventional systems and techniques. The initial participant is, therefore, relieved of some of the burden of organizing the meeting, so that errors are avoided or mitigated and individual productivity is enhanced.

### Hierarchy

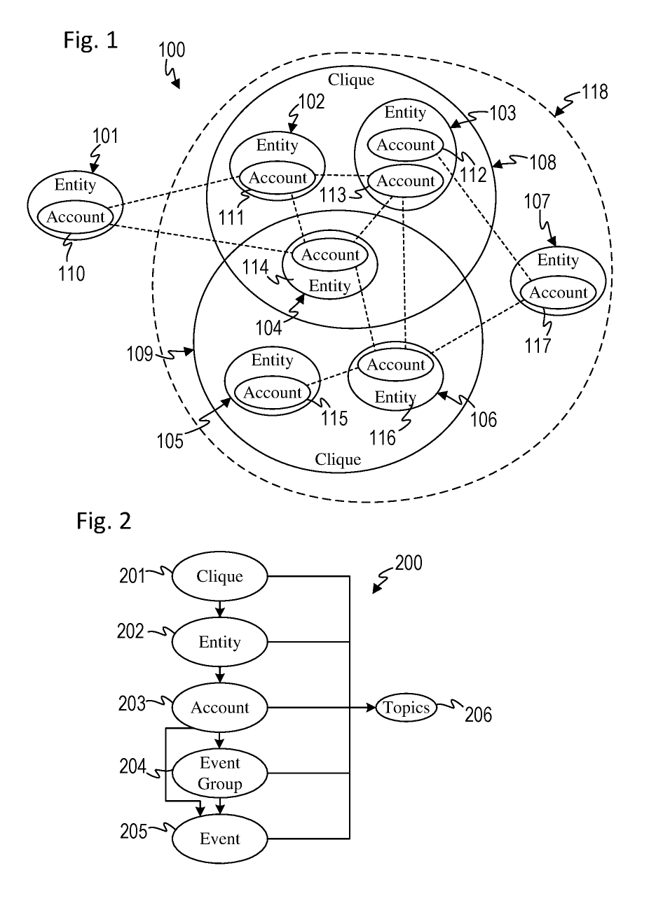

In some embodiments, the meeting setup system and technique use a hierarchy of data types to organize the data for the various entities and their related topics, as illustrated by FIGS. 1 and 2. FIG. 1 shows a simplified diagram of an example interconnection environment 100 in which several entities 101-107 communicate or work together. FIG. 2 shows the levels for the hierarchical data types arranged in a hierarchy 200. Other embodiments may have different data types arranged in a different order or combination and with different type definitions.

Some of the entities 102/103/104 and 104/105/106 are grouped together in cliques 108 and 109, respectively. Therefore, in the illustrated embodiment, the clique level 201 is at the top level of the hierarchy 200, and the entity level 202 is directly below that. Each entity 101-107 at the entity level 202 represents a unique instance of a person or a business. In some embodiments, an entity is a unit that cannot be duplicated in the meeting setup system, since there can be only one of each person or business organization. Each clique 108 or 109 at the clique level 201, on the other hand, is any appropriate grouping of some of the entities (e.g., 102/103/104 or 104/105/106), such as in teams of people, groups of friends, workgroups of co-workers, employees of a business division (or of the overall business), among other types of groupings. A clique 108 or 109 may be created formally (e.g., by intentionally linking entities together in the meeting setup system) or ad hoc (e.g., by the fact that some entities frequently communicate with each other, as determined by the meeting setup system). An entity (e.g., 104) can be a member of, or be linked to, more than one clique (e.g., both 108 and 109), but not every entity (e.g., 101 and 107) is necessarily a member of a clique.

Each entity 101-107 is represented by one or more account 110-117. (The entity 103, for example, is shown represented by two accounts 112 and 113.) Therefore, directly below the entity level 202 is the account level 203. Each account 110-117 at the account level 203 is an entity's ID, handle or designator to an individual service that is investigated or monitored by the meeting setup system. For example, accounts can be designated by an email address, a Facebook™ name, a Twitter™ handle, a meeting room number, or an individual's calendar (among others) for an email account, a Facebook™ account, a Twitter™ account, a meeting room location, or a calendar application, respectively, that are tied into, referenced by, or accessible to, the meeting setup system. The entities 101-107 are unifying points between the various accounts 110-117, since each account 110-117 typically belongs to, or is linked with, only one entity 101-107, but each entity 101-107 typically can have more than one account 110-117. In some embodiments, a single account can belong to multiple entities, such as in a department of a business enterprise that uses a single email address for some or all of its staff members, or in a business enterprise that has multiple agents managing a single social media account (e.g., wherein the enterprise entity is linked to the account as owner, and each individual agent entity is linked as a user). In the examples that follow, however, each account is assumed to belong to one entity.

Below the account level 203 is the event group level 204. An event group at the event group level 204 is a logical grouping of events (defined below) linked to one or more accounts 110-117, but not every event is necessarily linked to an event group. For example, an email thread is a logical grouping of multiple related emails (an email being an example of an event) between the same email accounts, but an individual email might not be part of a larger email thread. Each account 110-117 can have, or be linked to, any number of event groups, and each event group can be linked to any number of accounts 110-117.

Below the account level 203 and the event group level 204 is the event level 205. An event at the event level 205 is an individual item that belongs, or is linked, to one or more accounts 110-117 in the meeting setup system. Events include data for prior and/or future meetings or appointments logged in calendar applications, prior emails exchanged between email accounts, posts in social networks, attachments (e.g., documents or other artifacts) in emails, chat or SMS messages, etc. Each account 110-117 and event group can have, or be linked to, any number of events, and each event can be linked to any number of accounts 110-117 or event groups.

Rather than being a separate level in the hierarchy 200, topics 206 are treated in parallel to the hierarchical data types 201-205. A topic 206 can reference, or be linked to, any number of any hierarchical data types 201-205, and each of the hierarchical data types 201-205 can be linked to any number of topics 206. The topics 206 are generally produced by the meeting setup system, as described below, from data associated with the events and then linked to those events and to every event group, account 110-117, entity 101-107, and clique 108 or 109 to which those events are linked within the hierarchy 200.

All of the entities 101-107 and cliques 108 and 109 are referenced within the meeting setup system, meaning that they each have an entry in a database of the meeting setup system, as described below. The entities 102-107 (and the cliques 108 and 109) are shown in FIG. 1 encompassed by a dashed line 118 to indicate that they are “directly” participating in the meeting setup system, meaning that the present system has direct access (as described below) to the source services for the accounts 111-117 of each entity 102-107, so that the present system can gather the various types of information (e.g., due to events) from the variety of different source services and analyze the information to extract, classify and store the data regarding relationships and linkages between the cliques 108 and 109, the entities 102-107, the accounts 111-117, the event groups, the events, and the topics 206. However, the entity 101 is shown outside the dashed line 118 to indicate that it is not directly participating in the present system, meaning that the present system does not have access to the source services for the account 110 of the entity 101 for gathering information. Instead, the entity 101 and the account 110 are referenced within the present system, because one of the other entities 102-107 communicated with the entity 101 (e.g., to the account 110) via one of their accounts 111-117, and the present system extracted the information for the entity 101 and the account 110 when it analyzed the event of that communication.

### Graph Database

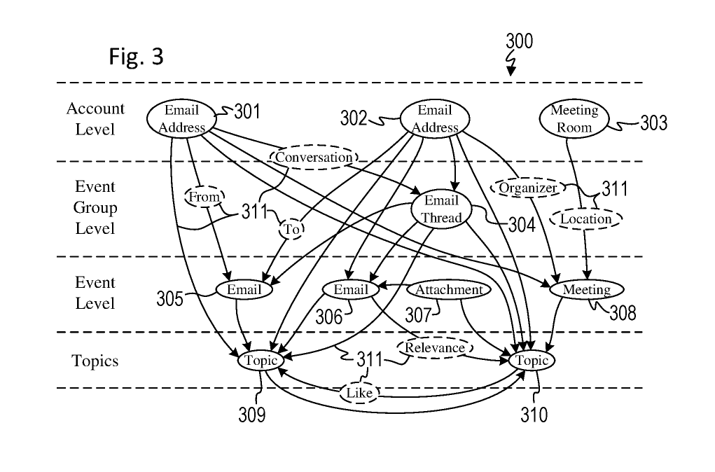

As illustrated in FIG. 3, in some embodiments, the data for the entries of the items at all levels of the hierarchy 200 and the relationships and linkages between them is stored or maintained in a NoSQL (“non SQL” or “non relational”) database, such as a graph database 300. The graph database 300 provides or enables a coherent and intuitive presentation of the data it holds, thereby allowing a rapid traversal of a pattern of data in the database or of interactions or relationships between a plurality of data items and/or properties of the data items. Each data item (also referred to as a member) is stored as a node, vertex or block (“vertex”) 301-310 in the graph database 300 using a plurality of different vertex types, instead of in a plurality of different tables with indexes between the tables, as in a “relational database.” Additionally, relationships between the various data items are presented as directional “edges” 311 connecting the vertices 301-310. The particular example entries (vertices 301-310 and edges 311) for the graphical representation of the graph database 300 shown in FIG. 3 are provided for illustrative and descriptive purposes only for some embodiments. Other embodiments may use different appropriate types of vertices and edges. The clique level and entity level entries are not shown for simplicity.

### Vertices

In the illustrated example, several different vertex types are used. At the account level, for example, the vertices 301 and 302 are entity ID account vertices (e.g., email address account vertices, social media account vertices, etc.), and the vertex 303 is a meeting room account vertex. At the event group level, the vertex 304 is an email thread event group vertex. At the event level, the vertices 305 and 306 are email event vertices, the vertex 307 is an attachment event vertex, and the vertex 308 is a meeting event vertex. Additionally, the vertices 309 and 310 are topic vertices. Other types of vertices, e.g., to designate the cliques 108 and 109 and/or the entities 101-107, may be used in other embodiments.

The entity ID account vertices 301 and 302 represent, or correspond to, email addresses of email accounts that are accessed by the present system and belong to some of the entities 101-107. Through the entity ID account vertices 301 and 302, the graph database 300 provides a mapping of associations between the entities 101-107 through the various connections, links and relations represented by the other vertices 303-310 and the edges 311. In some embodiments, each entity ID account vertex 301 or 302 is uniquely designated by an email address ID, such as the corresponding email address itself.

The meeting room account vertex 303 represents, or corresponds to, a physical space where meetings typically take place, such as a designated conference room, classroom, banquet hall, etc., within the premises of an enterprise or entity that subscribes to the present system. In some embodiments, the meeting room account vertex 303 is uniquely designated by a meeting room ID, such as a room number/name or another email address assigned specifically to the meeting room. The meeting room account vertex 303 also generally specifies various artifacts related to the meeting room, such as participant/seating capacity or presence/absence of certain equipment, e.g., whiteboard, projector, network connection, speaker phone, etc.

The email thread event group vertex 304 represents, or corresponds to, a group of emails within a conversation or a thread, as defined by email systems that are accessed by the present system and are used by some of the entities 101-107. In some embodiments, the email thread event group vertex 304 is uniquely designated by a thread ID, such as the ConversationID property value (used by Microsoft Exchange™ to identify a conversation thread) or other similar values used by other email systems.

The email event vertices 305 and 306 represent, or correspond to, individual emails that have been sent or received through any of the email accounts that are accessed by the present system and belong to some of the entities 101-107. In some embodiments, each email event vertex 305 and 306 is uniquely designated by an email ID, such as the Microsoft Exchange™ ID value (used by Microsoft Exchange™ to identify an email), the UniqueId field value, the Gmail™ ID value, or other similar values used by other email systems.

The attachment event vertex 307 represents, or corresponds to, an attachment or file that was transmitted with an email, such as the email that corresponds to the email event vertex 306. In some embodiments, the attachment event vertex 307 is uniquely designated by an attachment ID, such as another Microsoft Exchange™ ID value (used by Microsoft Exchange™ to identify an email attachment) or other similar values used by other email systems.

The meeting event vertex 308 represents, or corresponds to, a single instance of a meeting that has occurred or will occur involving at least one of the entities 102-107 that are directly participating in the present system. In some embodiments, the meeting event vertex 308 is uniquely designated by a meeting ID, such as another Microsoft Exchange™ ID value (used by Microsoft Exchange™ to identify a meeting or calendar event) or other similar values used by other calendaring systems.

The topic vertices 309 and 310 represent, or correspond to, a word, phrase or n-gram. (An n-gram is a contiguous sequence of n items or characters of a sequence of text or speech. The n items can be phonemes, syllables, letters, words or base pairs according to the application. When the n items are words, n-grams may also be called shingles.) The words, phrases or n-grams typically are collected or extracted (as described below) from a text or speech corpus contained within, or associated with, the data items represented by the other vertices 301-308. In some embodiments, the topic vertices 309 and 310 are uniquely designated by a text value, such as the word, phrase or n-gram string that constitutes the topic itself.

In some embodiments, the data structure for each vertex 301-310 generally includes vertex data fields for a vertex ID value, a vertex UUID value, a vertex label, and vertex properties. Other embodiments may include other appropriate data fields or combinations of data fields.

The vertex ID value field contains a unique identifier for the vertex 301-310. The vertex ID value is assigned by a database program that maintains the graph database 300, e.g., the Titan™ open source graph database from DataStax, Inc., or other appropriate database program. In some embodiments, the vertex ID value is an integer value that is assigned to the vertex 301-310 in addition to, or instead of, the vertex UUID value. In some embodiments, in some stages or phases of the overall process (e.g., during the preprocessing phase described below before a new vertex is inserted into the graph database 300), some or all of the vertices 301-310 will not yet have the vertex ID value specified. However, if the vertex ID value is not specified, then the vertex UUID value is specified.

The vertex UUID value field contains another unique identifier for the vertex 301-310. The vertex UUID value is assigned by a database interface that processes, inserts and fetches data to and from the graph database. In some embodiments, the vertex UUID value is used to uniquely designate the vertex 301-310, as mentioned above. For example, the vertex UUID value for the entity ID account vertex 301 or 302 may be the corresponding email address. For another example, the vertex UUID value for the email event vertex 305 or 306 may be the Microsoft Exchange™ ID value, the UniqueId field value, the Gmail™ ID value, or other similar values used by other email systems. Thus, in some embodiments, the vertex UUID value is a non-integer value.

In some embodiments, at least one of either the vertex ID value or the vertex UUID value must be specified, so that the vertex 301-310 can be identified in some manner. In some embodiments, the present system may prefer, or operate more easily with, one of these values (e.g., the vertex ID value) over the other, so that if the preferred value is provided, then the other is ignored during operations.

The vertex label field contains a value or string that indicates the type of the vertex 301-310. Examples of several different vertex types are described above.

The vertex properties field contains one or more values or attributes that are different for the vertices 301-310 depending on the vertex type. The vertex properties field is, thus, a key value store. For the email event vertex 305 or 306, for example, the properties generally include the date of the email and the contents of the subject and the body of the corresponding email, among other potential email properties. For the meeting event vertex 308, the properties generally include the date of the meeting, among other potential meeting properties. For the meeting room account vertex 303, the properties generally include the various artifacts related to the meeting room, such as participant/seating capacity or presence/absence of certain equipment, e.g., whiteboard, projector, network connection, speaker phone, etc., among other potential meeting room properties. For the entity ID account vertices 301 and 302, the properties generally include the name, office location, additional contact information, job title, job hierarchy position, or seniority, among other potential email or entity properties, for the entity 101-107 to which the email address account belongs. For the topic vertices 309 and 310, the properties generally include the words or phrases that comprise the topic, among other potential topic properties.

### Edges

Additionally, in the illustrated example, several different edge types, or relations, are used for the edges 311. In some embodiments, there is only a single edge 311 of a given edge type between any two of the vertices 301-310. For simplicity of illustration, only some of the edges 311 are labelled in FIG. 3 with their edge type, but every edge 311 has an edge type. The edges 311 are typically directional, i.e., point from one vertex to another, as indicated by the arrows shown for the edges 311, which indicate or enforce the tiered hierarchical nature of the data types 201-205. In some embodiments, additional edges (having the same, similar or different descriptions given herein for the edges 311) may be used to connect, and show the relations between, the cliques 108 and 109 and the entities 101-107 with the vertices 301-310. In some embodiments, the edges 311 that connect the topic vertices 309 and 310 to the other vertices 301-308 are called “Relevance” edges (or “Topic edges”), as described below, but there are a variety of non-Relevance edges (or “non-Topic edges”) that connect the other vertices 301-308 to each other.

In some embodiments, the edges 311 from the entity ID account vertices 301 and 302 to the email thread event group vertex 304 are of a “Conversation” edge type, indicating that the email addresses of the entity ID account vertices 301 and 302 have been involved in the conversation represented by the email thread of the email thread event group vertex 304. Each email thread event group vertex 304 can have any number of edges 311 pointing to it of the “Conversation” edge type, since an email thread typically involves any number of participants. Each entity ID account vertex 301 or 302 can have multiple outbound “Conversation” edges 311, since an email account can participate in any number of email threads. Additionally, the edges from the email thread event group vertex 304 to the email event vertices 305 and 306 are of an “Event” edge type. Each email event vertex 305 or 306 can typically have only one edge 311 pointing to it of the Event edge type, since an email is typically a part of only one thread; but each email thread event group vertex 304 can have multiple outbound instances of this edge type, since an email thread can have more than one email.

In some embodiments, the edges 311 from the entity ID account vertices 301 and 302 to the email event vertices 305 and 306 represent a variety of different edge types. The following are examples of such edge types, but other embodiments may use different, additional, more or fewer edge types or relations between the entity ID account vertices 301 and 302 and the email event vertices 305 and 306.

For example, a “From” or “Sender” edge type signifies that the email address of the entity ID account vertex 301 or 302 is in the “From” or “Sender” field of the email of the email event vertex 305 or 306, meaning that the email was sent from that email address. Each email event vertex 305 or 306 typically has only one edge 311 pointing to it of the “From” or “Sender” edge type, since an email typically has only one sender; but each entity ID account vertex 301 or 302 can have multiple outbound “From” or “Sender” edges 311, since an email account can be used to send multiple emails.

A “Reply To” edge type signifies that the email address of the entity ID account vertex 301 or 302 is in the “Reply To” field of the email of the email event vertex 305 or 306, meaning that performing a “Reply To” function in an email program would cause that email address to appear in a “To” field in an outgoing email, typically in order for a recipient of the email to respond back to the sender. (Usually, but not always, the “Reply To” email address is the same as the “From” or “Sender” email address.) Each email event vertex 305 or 306 typically has only one edge 311 pointing to it of the “Reply To” edge type, since each email typically has only one email address for a reply (usually the sender email address); but each entity ID account vertex 301 or 302 can have multiple outbound “Reply To” edges 311, since an email address can be used to receive replies in response to multiple emails.

A “To” edge type signifies that the email address of the entity ID account vertex 301 or 302 is in the “To” field of the email of the email event vertex 305 or 306, meaning that the email was addressed directly to that email address (a “TO” recipient). Each email event vertex 305 or 306 can have any number of edges 311 pointing to it of the “To” edge type, since an email can typically be addressed to any number of recipients. Each entity ID account vertex 301 or 302 can have multiple outbound “To” edges 311, since an email account can be used to receive multiple emails.

A “CC” edge type signifies that the email address of the entity ID account vertex 301 or 302 is in the “CC” field of the email of the email event vertex 305 or 306, meaning that the email was addressed to that email address through the carbon copy feature (a “CC” recipient). Each email event vertex 305 or 306 can have any number of edges 311 pointing to it of the “CC” edge type, since an email can typically be addressed to any number of carbon copy recipients. Each entity ID account vertex 301 or 302 can have multiple outbound “CC” edges 311, since an email account can be used to receive multiple emails.

A “BCC” edge type signifies that the email address of the entity ID account vertex 301 or 302 is in the “BCC” field of the email of the email event vertex 305 or 306, meaning that the email was addressed to that email address through the blind carbon copy feature (a “BCC” recipient). Each email event vertex 305 or 306 can have any number of edges 311 pointing to it of the “BCC” edge type, since an email can typically be addressed to any number of blind carbon copy recipients. Each entity ID account vertex 301 or 302 can have multiple outbound “BCC” edges 311, since an email account can be used to receive multiple emails.

A “Received By” edge type signifies that the email address of the entity ID account vertex 301 or 302 is in the “Received By” field of the email of the email event vertex 305 or 306, meaning that the email was received by that email address. In some embodiments, during a data collection process described below, before data of a received email for an email event vertex 305 or 306 is entered into the graph database 300, the edge data generated for the received email includes only one “Received By” entry, because the data for each event is generated from the individual accounts 301 or 302. However, the same email can be collected from multiple accounts 301 and 302 that received it, so that when the data is merged and entered into the graph database 300, each email event vertex 305 or 306 can have any number of edges 311 pointing to it of the “Received By” edge type, since any number of recipients can typically receive a given email. Each entity ID account vertex 301 or 302 can have multiple outbound “Received By” edges 311, since an email account can be used to receive multiple emails.

A “Received Representing” edge type signifies that the email address of the entity ID account vertex 301 or 302 is in the “Received Representing” field of the email of the email event vertex 305 or 306, meaning that the email was received by that email address, but that email address was representing another email address. In some embodiments, during the data collection process described below, before data of a received email for an email event vertex 305 or 306 is entered into the graph database 300, the edge data generated for the received email includes only one “Received Representing” entry, because the data for each event is generated from the individual accounts 301 or 302. However, the same email can be collected from multiple accounts 301 and 302 that received it representing another account, so that when the data is merged and entered into the graph database 300, each email event vertex 305 or 306 can have any number of edges 311 pointing to it of the “Received Representing” edge type, since any number of recipients can typically be represented by another email address to receive a given email. Each entity ID account vertex 301 or 302 can have multiple outbound “Received Representing” edges 311, since an email account can be used to receive multiple emails.

In some embodiments, the edge 311 from the attachment event vertex 307 to the email event vertex 306 is of an “Attached” edge type, indicating that the file of the attachment event vertex 307 was attached to, or transmitted with, the email of the email event vertex 306. The email event vertex 306 can have any number (zero or more) of edges 311 pointing to it of the “Attached” edge type, since an email can have zero, one or more attachments. In some embodiments, to save storage space and unnecessary data redundancy, if the same file is attached to multiple emails (e.g., when an email with an attachment gets forwarded to additional recipients), then the same attachment event vertex 307 can be used for each email event vertex 306, in which case the attachment event vertex 307 will have multiple outbound “Attached” edge 311. In other embodiments, if the same file is attached to multiple emails, then a different attachment event vertex 307 can be used for each email event vertex 306, in which case each attachment event vertex 307 will have only one outbound “Attached” edge 311.

In some embodiments, the edge 311 from the meeting room account vertex 303 to the meeting event vertex 308 is of a “Location” edge type, indicating that the physical space of the meeting room account vertex 303 was, or will be, used as the location for the meeting of the meeting event vertex 308. A meeting for which all of the attendees are present in the same physical space will have a meeting event vertex 308 with only one edge 311 pointing to it of the “Location” edge type. However, a meeting for which the attendees are present at different physical spaces, such as when a video conference bridge is used between two conference rooms with attendees at both locations, can have a meeting event vertex 308 with multiple edges 311 pointing to it of the “Location” edge type. Each meeting room account vertex 303 typically has multiple outbound “Location” edges 311, since the same physical meeting space is usually used for many different meetings.

In some embodiments, the edges 311 from the entity ID account vertices 301 and 302 to the meeting event vertex 308 represent a variety of different edge types. For example, the edges 311 from the entity ID account vertices 301 and 302 to the meeting event vertex 308 can be of an “Organizer,” “Required Attendee,” or “Optional Attendee” edge type. Other embodiments may use different, additional, more or fewer edge types or relations between the entity ID account vertices 301 and 302 and the meeting event vertex 308.

The “Organizer” edge type signifies that the entity associated with the email address of the entity ID account vertex 301 or 302 organized the meeting of the meeting event vertex 308. Each meeting event vertex 308 can have only one edge 311 pointing to it of the “Organizer” edge type, since a meeting typically has one person who is responsible for setting it up; but each entity ID account vertex 301 or 302 can have multiple outbound “Organizer” edges 311, since an email account can be used to set up multiple meetings.

The “Required Attendee” edge type signifies that the entity associated with the email address of the entity ID account vertex 301 or 302 was invited to, and was required to participate in, the meeting of the meeting event vertex 308. Each meeting event vertex 308 can have any number of edges 311 pointing to it of the “Required Attendee” edge type, since a meeting can have any number of people who must attend; and each entity ID account vertex 301 or 302 can have multiple outbound “Required Attendee” edges 311, since the person with that email account can be invited to, and be required to attend, multiple meetings.

The “Optional Attendee” edge type signifies that the entity associated with the email address of the entity ID account vertex 301 or 302 was invited to, but was not necessarily required to participate in, the meeting of the meeting event vertex 308. Each meeting event vertex 308 can have any number of edges 311 pointing to it of the “Optional Attendee” edge type, since a meeting can have any number of people who may attend, but are not required to attend; and each entity ID account vertex 301 or 302 can have multiple outbound “Optional Attendee” edges 311, since the person with that email account can be invited to multiple meetings, regardless of whether required to attend.

In some embodiments, the Topic edges 311 from the topic vertices 309 and 310 to the other vertices 301-308 are of a “Relevance” edge type, indicating the relative relevance of the data items (represented by or corresponding to the other vertices 301-308) to the topics (of the topic vertices 309 and 310). Thus, the “Relevance” edges 311 contain a value for the weight of the relevance of the data item to the topic. Additionally, in some embodiments, the “Relevance” edges 311 contain a state of a classifier (e.g., a Bayesian or other appropriate classifier function) that is used to update the relevance. In some embodiments, the value of the weight of the relevance (the “relevance weight”) is in a range or scale from 0 to 1, where one is most relevant, and zero is least relevant. In some embodiments, the Topic edges 311 are provided only between the topic vertices 309 and 310 and the event vertices 305-308, and not between the topic vertices 309 and 310 and the vertices 301-304 of the higher hierarchical layers for the account level or the event group level. In this case, the relevance weights between the vertices 301-304 of the higher hierarchical layers and the topic vertices 309 and 310 are calculated based on 1) the edges 311 between the vertices 301-304 and the event vertices 305-308, and 2) the topic edges 311 between the event vertices 305-308 and the topic vertices 309 and 310. Thus, the graph database 300 is traversed through every path between the vertices 301-304 and the topic vertices 309 and 310 through the event vertices 305-308, and the relevance weight for each path depends on the relevance weight of the topic edges 311 traversed for each path. However, embodiments that provide the Topic edges 311 between the topic vertices 309 and 310 and the vertices 301-304 of the higher hierarchical layers, as well as between the topic vertices 309 and 310 and the event vertices 305-308, generally exhibit enhanced performance during the meeting setup process, since the relevance weights for the entity ID account vertices 301 and 302 to the topic vertices 309 and 310 will have already been calculated at that point.

Some embodiments include edges 311 of a “Like,” “Similar,” or “Related” edge type between individual topics 309 and 310. In some embodiments, these types of edges 311 link the topics 309 and 310 that have words or phrases that have been detected to be synonyms for each other and/or to frequently occur together in the same event data. In some embodiments, if a business enterprise or group uses names or identifiers for various projects, then it generates topic vertices 309/310 for the project names and links them through these types of edges 311 to other topic vertices 309/310 containing words or phrases related to the projects. Thus, any word or phrase can be linked to another related word or phrase, even if they are not actual synonyms or otherwise naturally related.

In some embodiments, the data structure for each edge 311 generally includes edge data fields for an edge ID value, a TO value, a FROM value, an edge label, and edge properties. Other embodiments may include other appropriate data fields or combinations of data fields.

The edge ID value field contains a unique identifier for the edge 311. The edge ID value is assigned by the processing program (described herein) that generates the data for the edges 311 or by the database program that maintains the graph database 300. In some embodiments, the edge ID value is a variable character (e.g., varchar) or an integer value that is assigned to the edge 311. In some embodiments, not all of the edges 311 have the edge ID value specified, but if the edge ID value is not specified, then the TO value, the FROM value, and the edge label are specified.

The TO value field contains an identifier (e.g., the vertex ID value or the vertex UUID value) for the vertex 301-310 for which the edge 311 is incoming. The FROM value field contains an identifier (e.g., the vertex ID value or the vertex UUID value) for the vertex 301-310 for which the edge 311 is outgoing. With these fields, which are indicated by the arrows shown on the edges 311, the present system can determine which vertex 301-310 to go to when traversing the tiered hierarchy of the graph database 300. In some embodiments, the “Like” edges 311 between the topic vertices 309/310 have fields similar to the TO and FROM value fields that simply identify the two topic vertices 309/310 that are linked together, with or without directionality.

The edge label field contains a value or string that indicates the type of the edge 311. Examples of several different edge types are described above.

The edge properties field contains one or more values or attributes that can be different for the edges 311 depending on the edge type. For example, the edge properties field for the Relevance edges between topic vertices 309/310 and other vertices 301-308 contain a key value store, which has a value of the relevance weight calculated by an algorithm, as described below. Additionally, in some embodiments, a variety of different algorithms can be used to calculate the key value score in different manners to arrive at different values. Furthermore, new algorithms can be put into service to provide different relevance weight formulas, and old algorithms can be discontinued without changing the relevance weights previously calculated with them. Therefore, the edge properties field also contains an indication of the algorithm used to calculate the relevance weight contained therein.

### Example System Architecture

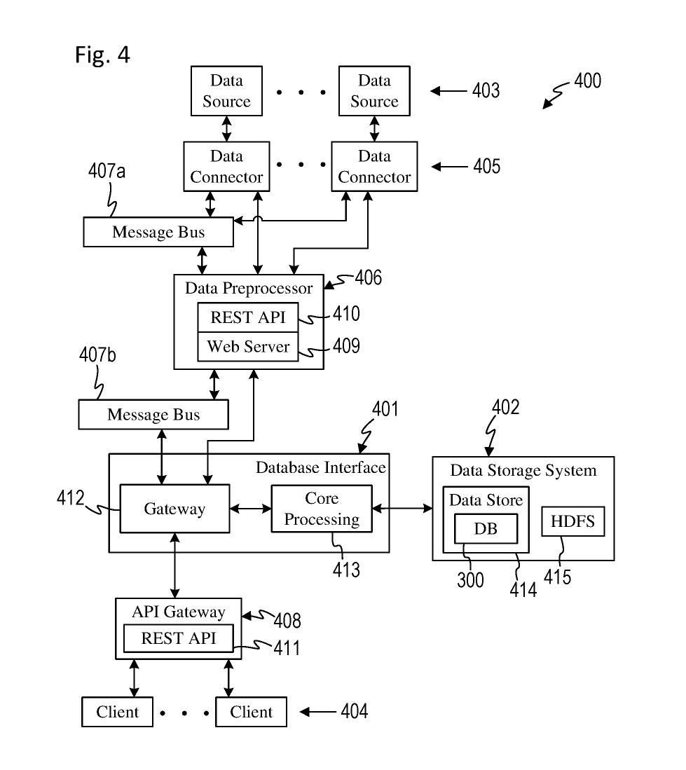

An architecture for an example meeting setup system 400 is shown in FIG. 4 in accordance with some embodiments. In the illustrated embodiment, the meeting setup system 400 generally includes a database interface system 401 and a data storage system 402 for gathering the types of data described above from a variety of different data source services 403, analyzing and processing of the data to generate the graph database 300, receiving meeting topic requests from a variety of different client devices 404, and producing a recommendation for a potential meeting based on the meeting topic and the contents of the graph database 300, among other functions. Additionally, the illustrated embodiment of the meeting setup system 400 further includes various data connectors 405, one or more data preprocessor 406, one or more message buses 407(a and b), and an application programming interface (API) gateway 408, among other possible components not shown for simplicity. Furthermore, the components 401-408 of the meeting setup system 400 are connected together by multiple wired and/or wireless data channel, communication, or networking components of various types, which are represented by unlabeled arrows between the components. In some embodiments, the components of the meeting setup system 400 are microservices based, so the architecture can be vertically and/or horizontally scaled out. Other embodiments may use different, additional, more or fewer components to achieve a similar purpose described below. Features or functions described for one of the components may be enabled in a different component in some embodiments.

The client devices 404 typically belong to, are associated with, or are used by, the entities 102-107 (or the accounts 111-117 or entity ID account vertices 301 and 302 of the entities 102-107) that are “directly” participating in the meeting setup system 400, as mentioned above. Additionally, the data source services 403 provide the various email, social network, instant messaging, chat, calendaring, applications (e.g., Google™ apps), blog, web site, wiki page, etc. services for the accounts 111-117 of the entities 102-107. Thus, the client devices 404 generally represent any appropriate electronic devices, such as mobile phones, smart phones, PDAs, notebook/laptop computers, tablet computers, desktop computers, workstation computers, game consoles, etc., for accessing the accounts 111-117 and the meeting setup system 400 by the entities 102-107 or users representing the entities 102-107.

In some embodiments, the meeting setup system 400 includes the various data connectors 405, the data preprocessor 406 and the message buses 407(a and b), among other possible communication, interface and/or access components not shown for simplicity, for accessing, investigating, monitoring or communicating with the data source services 403 and providing data from the data source services 403 to the database interface system 401. Other embodiments may use different, additional, more or fewer communication, interface and/or access components to achieve a similar purpose of collecting the desired data, as described below.

The data connectors 405 generally represent appropriate hardware (e.g., processors, memory, etc.) and/or software for connecting to, or accessing, the data source services 403 in order to receive and transmit account data from the data source services 403 to the data preprocessor 406. For example, one or more data connectors 405 can connect with the data source service 403 of Microsoft Outlook™ to read email and calendar information for the email and calendar accounts of the entity 102-107. Additionally, the interface between one of the data connectors 405 and its corresponding data source service 403 is typically source specific. For instance, for accessing Microsoft Outlook™, the data connector 405 can use a Simple Object Access Protocol (SOAP) API. On the other hand, for accessing the data source service 403 of ShoreTel IM™ archives, the data connector 405 can use either a ShoreTel API or direct file or database access to the archives. In other embodiments, the data connectors 405 reside, or are installed, on the client devices 404 and screens, or intercepts, the emails, calendar entries, instant messages, etc. that are generated on or received by the client devices 404.

The data preprocessor 406 generally represents appropriate hardware (e.g., processors, memory, etc.) and software that can connect to and communicate with the data connectors 405, the database interface system 401 and the message buses 407(a and b) in order to receive and transmit data. In some embodiments, the data preprocessor 406 in FIG. 4 represents more than one data preprocessor 406, e.g., with each data preprocessor 406 responsible for processing a different data type or type of event or event group 304-308. In some embodiments, the data preprocessor 406 is combined with, included in, or hosted on, a web server 409. In some embodiments, the data preprocessor 406 receives and stores data in a JavaScript Object Notation (JSON) format through a REpresentational State Transfer (REST) API interface 410 or other appropriate standard interface. The data preprocessor 406 generally receives the account data from the data connectors 405 and performs various preprocessing operations on the data. For example, in some embodiments the preprocessing operations include text preparation operations, such as cleaning the data, filling in missing values, converting the format of the data, aggregating the data, and normalizing the data, among other potential text preparation preprocessing operations. In some embodiments, the preprocessing operations of the data preprocessor 406 include vertex and edge generation and topic extraction operations described herein, such as using the received data to generate the data described above for the vertices 301-310 and the edges 311, so that such data is ready to be inserted into the graph database 300 in the data storage system 402 upon being transferred to the database interface system 401. In some embodiments, the various preprocessing functions described herein for text preparation, vertex and edge generation, and topic extraction are provided as a single combined process (e.g., within a single data preprocessor 406 for a given data type) or as separate processes (e.g., within multiple data preprocessors 406 for a given data type). In some embodiments, some of the preprocessing functions can be performed by components of the database interface system 401. Other embodiments may perform different, additional, more or fewer preprocessing operations on the data. The data preprocessor 406 also transmits the preprocessed data to the database interface system 401. In some embodiments, the data preprocessor 406 communicates directly with the database interface system 401 for real time data communication. In some embodiments, the data preprocessor 406 communicates with the database interface system 401 through the message bus 407b, in addition to, or instead of, the direct communication.

The message buses 407(a and b) serve as a connecting middleware or focal point for transporting messages between systems or applications (e.g., the data preprocessor 406 and the database interface system 401), so the systems or applications do not experience a bottle-neck in their real time data transmissions. The message buses 407(a and b) are typically distributed for scale and persistent to tolerate failures. The message buses 407(a and b) store and transport the data and can handle data ingest at a high incoming rate. The message buses 407(a and b) generally use a common data model or set of agreed-upon message schemas, a set of common command messages, and a shared messaging infrastructure to allow the different systems or applications to communicate through a shared set of interfaces.

In some embodiments, the meeting setup system 400 further includes appropriate hardware and software for communicating with the client devices 404, such as the API gateway 408 with a REST API 411, among other possible communication/interface components not shown for simplicity. Other embodiments may use different, additional, more or fewer communication/interface components to achieve a similar purpose of transmitting to, and receiving data from, the client devices 404, as described below.

In some embodiments, the database interface system 401 generally includes a gateway process 412 and a core processing engine 413, among other possible components not shown for simplicity, for receiving the data from the preprocessor 406, forming/storing/maintaining the graph database 300, receiving the meeting topic requests from the client devices 404, and producing a recommendation for a potential meeting based on the meeting topic and the contents of the graph database 300, among other functions. Other embodiments may use different, additional, more or fewer components to achieve similar purposes.

The gateway process generally represents appropriate hardware (e.g., processors, memory, etc.) and software for receiving and transmitting data between the data preprocessor 406 (e.g., directly or through the message bus 407b), the client devices 404 (e.g., through the API gateway 408), and the core processing engine 413. In some embodiments, the gateway process 412 validates the data received from the data preprocessor 406 against appropriate schema to ensure that no invalid, corrupted or malicious data is written to graph database 300. The gateway 412 is also considered a serving layer in the database interface system 401 for servicing API requests. The gateway process 412 accepts and processes requests from other applications to run queries against the graph database 300. The gateway process 412 receives the meeting topic requests from the client devices 404, analyzes the requests and the data (stored in the graph database 300 and the data storage system 402), generates responses (e.g., recommendations for potential meetings), and transmits the responses to the client devices 404 through the API gateway 408 and REST API 411. The gateway process 412 uses the graph database 300 to map the associations between the entities 101-107. In some embodiments, the gateway process 412 stores the data for the graph database 300 in the data storage system 402, and also stores or caches part or all of the data in RAM memory for better performance. In some embodiments, the software for the gateway process 412 is distributed across multiple hardware processors and/or computing systems, e.g., for horizontal scalability. In some embodiments, since the data is on specific instances of the edges 311, the gateway process 412 is capable of redirecting an incoming request for data based on meta data, which may also be stored in the data storage system 402.

The core processing engine 413 generally represents appropriate hardware (e.g., processors, memory, etc.) and software for handling read and write access requests for the data in the graph database 300 in the data storage system 402. The core processing engine 413, thus, serves as the database layer.

The data storage system 402 generally represents appropriate hardware (e.g., processors, memory, persistent storage devices, etc.) and software for providing a persistent, scalable, high performance and fast-lookup data store 414 for the graph database (DB) 300. In some embodiments, the data storage system 402 is distributed across one or more networked physical storage units/housings/racks for greater reliability and scalability. Additionally, the data storage system 402 includes a scalable file system that is suitable for unstructured data (e.g., emails, attachments, IMs, historical data for creating analytics models, etc.) in large data sets, such as a Hadoop Distributed File System (HDFS) 415, with high throughput access to the data of the graph database 300.

### Data Collection

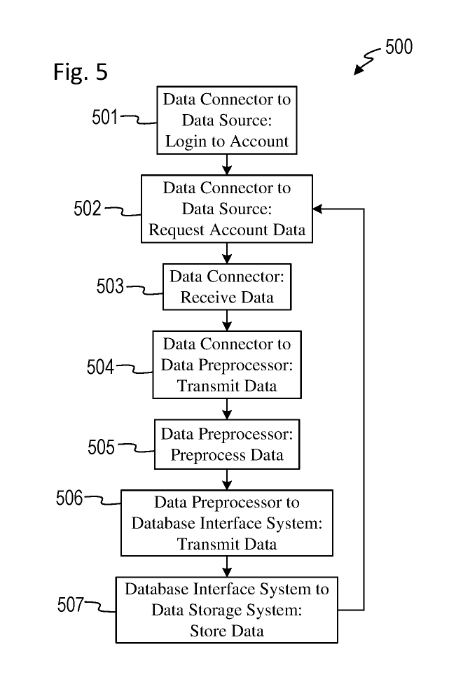

FIG. 5 shows a simplified flowchart for a data collection process 500 for the meeting setup system 400 to collect and store the data items for the graph database 300, in accordance with one or more example embodiments. The particular steps, combination of steps, and order of the steps are provided for illustrative purposes only. Other processes with different steps, combinations of steps, or orders of steps can also be used to achieve the same or similar result. Features or functions described for one of the steps performed by one of the components may be enabled in a different step or component in some embodiments.

Upon starting, the data connectors 405 login (at 501) to the corresponding data source services 403 through an appropriate data channel. To gain such access, the data connectors 405 are previously set up with appropriate user credentials (e.g., usernames, passwords, etc.) for accessing the email accounts, calendar accounts, social networking accounts, etc. of the entities 102-107. These user credentials are entered into the meeting setup system 400 (e.g., through an appropriate data channel from the client devices 404) when the entities 102-107, or someone acting on their behalf, register with the meeting setup system 400 (and provide to the meeting setup system 400 an identification of the data source services 403 that they use). Therefore, the receipt of the user credentials and the registration of the entities 102-107 causes the data connectors 405 (e.g., those corresponding to the data source services 403 identified by the entities 102-107) to transmit login requests (and the user credentials for the entities 102-107) to the corresponding data source services 403, which receive the user credentials and compare them to stored values. A match of received and stored credentials causes the data source service 403 to transmit a login succeed response to the data connector 405.

Receipt (and storage) of the login succeed response by the data connectors 405 causes the data connectors 405 to frequently or periodically transmit (at 502) account data requests (for the data associated with the accounts 111-117) to the corresponding data source services 403 through an appropriate data channel. Receipt (and storage) of the account data requests by the data source services 403 causes the data source services 403 to read and transmit the account data (or just account data that is new since a previous request) for the relevant accounts 111-117 to the data connectors 405 through an appropriate data channel. The data connectors 405 receive (and transiently store) the account data at 503.

Receipt (and transient storage) of a document, file or packet containing the account data by the data connectors 405 causes the data connectors 405 to transmit (at 504) the account data to the data preprocessor 406 through an appropriate data channel. For this transmission, the data connectors 405 push the account data through the data channel in real time or periodically directly to the data preprocessor 406 or through the message bus 407a. Additionally, any changes to the data source services 403 are propagated to the layers underneath in real time. In some embodiments, some of the data connectors 405 have appropriate in-built or configurable data filters. For example, the data connectors 405 for some email data source services 403 may filter out certain types of emails that are likely to be irrelevant to the overall purpose of the meeting setup system 400, such as spam emails or emails from automated email sources, e.g., SalesForceDotCom (SFDC) or a build agent. Furthermore, the data connectors 405 include various options or settings (e.g., selectable by an administrator) to ensure privacy and security of the collected data, so as to prevent unauthorized access to or usage of the data.

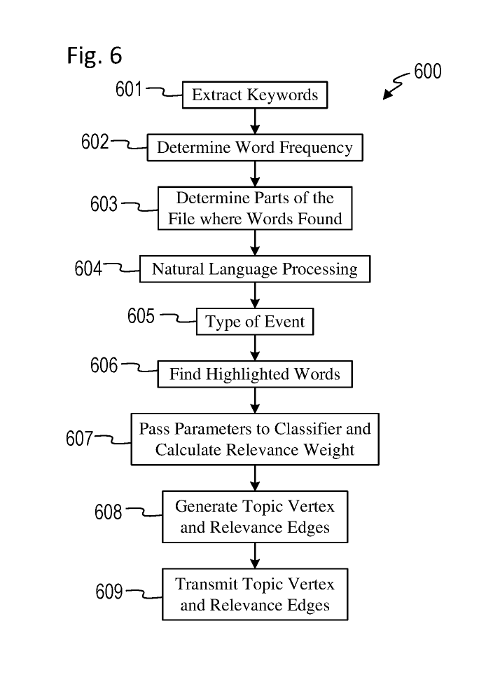

Receipt (and transient storage) of the account data by the data preprocessor 406 causes the data preprocessor 406 to perform (at 505) various preprocessing operations on the data, such as the text preparation, vertex and edge generation, and topic extraction operations, among other potential preprocessing operations. To perform the text preparation operations, the data preprocessor 406 reads the data and searches through it to find various characters or character strings, such as punctuation, formatting, tags, upper/lower case, etc. The data preprocessor 406 then deletes unnecessary punctuation, formatting and tags (e.g., as may be found in an html file, an rtf document, a Microsoft Word™ document, an email packet, a calendar app data structure, etc.) and normalizes the casing (e.g., changes all text characters to the same upper or lower case), so that only valid or plain text remains (except for text or font highlighting, as described below), or has been extracted, from the original raw account data to form initial preprocessed data. In some embodiments, font formatting of the text is retained in order to be used for further processing or classification, as described below. To perform the vertex and edge generation operations, the data preprocessor 406 reads the initial preprocessed data and searches through it to find the various data strings or values that indicate or identify the vertices 301-308 and non-topic edges 311 that are to be formed from the event data (e.g., email, calendar invite, etc.), as well as the various data strings or values either that comprise the vertex data fields and the edge data fields or from which the vertex data fields and the edge data fields are generated. Thus, the data preprocessor 406 reads through the initial preprocessed data and searches for tags or characters in order to parse the data to determine, or identify, relevant data therein for emails, email threads, calendar entries, topics, meeting rooms, time slots, meeting participants, etc. This parsed data, or derivative data generated from the parsed data, forms at least part of the vertex data and edge data for the fields of the data structures for the vertices 301-308 and the edges 311 between them for the graph database 300, as described above. The event vertices 305-308 and the event group vertex 304 are thus attached, or linked, to each other and to the accounts 301-303 as appropriate. For the topic extraction operations to form the topic vertices 309/310 and at least part of the data for the topic edges 311, the data preprocessor 406 performs some or all of the steps of a topic extraction process 600 described below with respect to FIG. 6.

The data preprocessor 406 then transmits (at 506) the preprocessed data through an appropriate data channel to the database interface system 401. To do so, in some embodiments, the data preprocessor 406 formats and packetizes the preprocessed data for communication directly with the database interface system 401, e.g., for real time data communication therewith, through the data channel. In other embodiments, the data preprocessor 406 formats and packetizes the preprocessed data for communication with the message bus 407b, and the message bus 407b transiently stores and then formats and packetizes the preprocessed data for communication with the database interface system 401.

Receipt (and storage) of a document, file or packet containing the preprocessed account data by the database interface system 401 (e.g., through the gateway process 412 and the processing engine 413) causes the database interface system 401 (e.g., through the gateway process 412 and the processing engine 413) to validate and store (at 507) the newly received data in the graph database 300 in the data storage system 402. In some embodiments, prior to storing the received data in the data storage system 402, the gateway process 412 or the core processing engine 413 reads the vertex ID value or vertex UUID value from the new data and issues access requests to the data storage system 402 to search the graph database 300 to find whether there is a match. The vertices 301-310 are treated as unique mergeable sets of data, so if a vertex 301-310 in the newly received data already exists, the gateway process 412 or the core processing engine 413 merges the new set of properties in the newly received data into the existing properties of the existing vertex 301-310 and stores the merged version in the graph database 300 in the data storage system 402. In the event that both sets of data contain the same key, the new value is kept. If the vertex 301-310 is new, i.e., the vertex ID value or vertex UUID value does not match that of an existing vertex 301-310, then the gateway process 412 or the core processing engine 413 creates and stores the new vertex 301-310 in the graph database 300 in the data storage system 402 and assigns a new vertex ID value.

The data collection process 500 is shown branching from 507 back to 502 (or back to 501 if login needs to be repeated). This branch is indicative of the continuing nature of the data collection process 500. However, in specific implementations, the various steps 501-507 are performed repeatedly without waiting for subsequent steps to complete before branching back. For example, the data connectors 405 are continually (e.g., periodically or when triggered) requesting (at 502) the account data from the data source services 403 while the data preprocessor 406 is continually performing (at 505) the various preprocessing operations on data that was passed through earlier. A similar overlap in step functions occur as appropriate for all of the steps 501-507.

### Topic Extraction

Topic extraction begins in the data preprocessor 406 after the text has been prepared and the vertices 301-308 and non-topic edges 311 have been identified. The classifier 412 generally uses the Graph database 300 to map potential associations between various entities (e.g., 101-107), accounts (e.g., for vertices 301-303), event groups (e.g., for vertex 304) and events (e.g., for vertices 305-308). In particular, the data preprocessor 406 extracts potential topics from the events and determines or classifies their potential relevance to those events and, thus, to the various entities, accounts, or event groups that are linked to those events. The topics and their relevance, therefore, provide the potential associations between the entities, the accounts, event groups and events. In some embodiments, the single most likely topic (e.g., the one with the highest overall relevance weight) is generated for, or derived from, the event data. In other embodiments, multiple potential topics (e.g., those with the highest overall relevance weights) are generated for, or derived from, the event data.

FIG. 6 shows a simplified flowchart for a topic extraction process 600 performed by the data preprocessor 406 to determine potential topics for the topic vertices 309 and 310 from the events (e.g., for the vertices 304-308) and the relevance relation of the topic vertices 309 and 310 to the other vertices 301-308 for the graph database 300, in accordance with one or more example embodiments. The particular steps, combination of steps, and order of the steps are provided for illustrative purposes only. Other processes with different steps, combinations of steps, or orders of steps can also be used to achieve the same or similar result. Features or functions described for one of the steps performed by one of the components may be enabled in a different step or component in some embodiments.

Upon starting, in some embodiments, the data preprocessor 406 generally performs (at 601) keyword or key phrase extraction on the document, file or packet containing the data of the events (e.g., for the vertex 304-308) as the event data arrives at the data preprocessor 406 (as described above). To do so, the data preprocessor 406 reads the event data and searches for words and/or phrases (or n-grams).

In some embodiments, the data preprocessor 406 is going to assign a score, or relevance weight, to the different words or phrases found in the event data that depends on a variety of factors related to the potential relevance of the words or phrases to the overall topic of the event (e.g., for the vertex 304-308). To do so, an internal state object on the account 111-117 or the event vertex 305-308 is updated with the event data. The relevance weight or relation between the account 111-117 (e.g., 301 or 302) or the event vertex 305-308 and relevant topics (e.g., for topic vertex 309 or 310) are then calculated from this state. In some embodiments, this is done by passing data for the state through an appropriate classifier (e.g., a Bayes-Classifier or other appropriate classifier function) to determine a probability that the topic is related to the event (e.g., for the vertex 304-308) and, thus, to the account 111-117 linked to the event (e.g., for the vertex 304-308). The classifier minimizes the probability of misclassification. Therefore, the resulting probability of correct classification is the relevance weight, and the relevance weight generally indicates the likelihood that the words or phrases that comprise the topic of the topic vertices 309-310 are in fact indicative of the actual topic or subject of the event.

In some embodiments, a variety of factors, parameters or heuristics contribute to the state and, thus, to the overall relevance weight that the words or phrases extracted from the event are indicative of the topic of the event. For example, words or phrases that appear more frequently in the event data are considered more likely to be relevant to the overall topic of the event (e.g., for the vertex 304-308) than are words that appear less frequently. Therefore, the data preprocessor 406 reads the event data and counts, or determines, (at 602) individual word or phrase frequency in the event data, in order to be able to assign a higher relevance weight to words that appear more frequently and a lower relevance weight to words that appear less frequently. One or more parameters or heuristics are thus produced for the word counts, word frequency percentages, or other values indicative of how more or less frequently various words or phrases occur in the event data. In some embodiments, similar consideration is given to word or phrase frequency within each paragraph (or other type of parts or sections) of the event data, file or document, so that potential topics are generated for each paragraph or section of the event data.

Additionally, in some embodiments, an email, a calendar invite, a blog post, a web page, a wiki page, or a Microsoft Word™ document (among other types of communications or documents) typically has a title and/or a subject line as well as a body portion (among other potential file sections). Additionally, a Microsoft Word™ document (among other types of files or documents, e.g., html files) typically has meta data or descriptive information, such as tags, comments and revision data, in addition to the body portion of the document. Words or phrases in the title, subject line or meta data are assumed to have a greater relation to the overall topic of the event (e.g., for the vertex 304-308) than do words or phrases that appear only in the body portion. Therefore, the data preprocessor 406 reads the event data and records, or determines, (at 603) the part or section of the file, data or document that the words or phrases are in, in order to be able to assign a higher relevance weight to words that appear in the title, subject line or meta data than it does to words found only in the body portion or other file sections. One or more parameters, heuristics or values are thus produced that are indicative of the part of the file in which the words or phrases occur in the event data. In some embodiments, if the event data includes a title or a subject line (or meta data or similar type of section), then an additional topic vertex 309 or 310 is added to the graph database 300. The additional topic vertex 309 or 310 is attached or linked to the event vertex 304-308 with a Relevance edge containing a relevance weight of 1 (on a scale of 0 to 1). In some embodiments, similar consideration is given to a file name as is given to a title or a subject line.

Also, in some embodiments, the data preprocessor 406 performs natural language processing (NLP) methodologies (at 604) on the data to tokenize and/or tag the parts of speech for the words in the document or file, since some parts of speech (e.g., nouns and verbs) may be considered more relevant than other parts of speech (e.g., adjectives and adverbs) to the overall topic of the event (e.g., for the vertex 304-308). Therefore, the data preprocessor 406 reads the data and searches for known nouns, verbs, adjectives, etc., in order to be able to assign a higher relevance weight to words used for the more relevant parts of speech. One or more parameters, heuristics or values are thus produced that relate the words or phrases to their parts of speech for the event data.

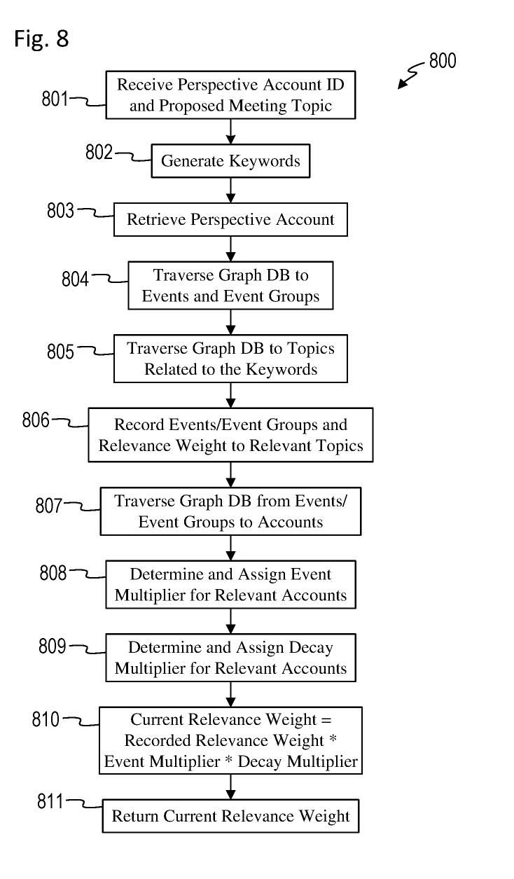

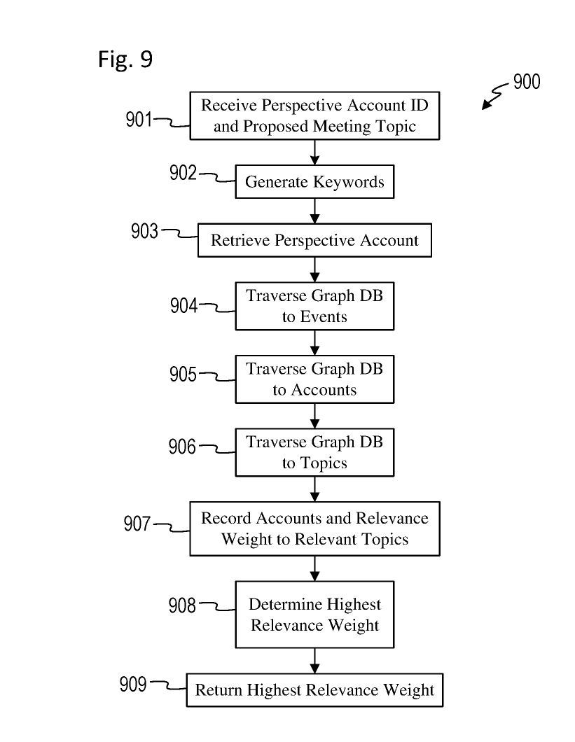

In addition, in some embodiments, the parties or participants for the present event (e.g., for the vertex 304-308) are likely to have been more interested in the topic of the event if the event were a meeting than if the event were an email. In particular, the entities 101-107 have to expend more time and effort to attend a meeting than they do to exchange an email, so a meeting event should carry a greater relevance weight than an email event. Therefore, at 605, the data preprocessor 406 reads the event data and searches through it to determine the type of the event. One or more parameters, heuristics or values are thus produced that increase the relevance weight of the words or phrases for the present event if the event is a meeting, rather than an email or other event type. Alternatively, the determination of the relevance weight at this stage may be done without regard to the type of event, which can then be taken into consideration when determining various multiplier values, as described below with respect to FIG. 8 or 9.

Additionally, in some embodiments, a person who prepares a document, email, etc. may use a different text or font format or style to highlight important words or phrases therein, which are assumed to have a greater relation to the topic of the document than other portions of the text. For example, some words or phrases in the document may be bolded, italicized or underlined; the text highlight color or the font color of some words or phrases may be different from that of surrounding text; or the font size of some words or phrases may be larger than that of surrounding text. Therefore, the data preprocessor 406 reads and searches through the event data to find (at 606) words or phrases highlighted in any of these manners. One or more parameters, heuristics or values are thus produced that are indicative of whether the words or phrases are highlighted in the event data.

In addition to the preceding examples, some embodiments may use other processing or classification techniques with other heuristics or fuzzy matching algorithms to establish additional factors that can help fine tune the overall relevance weight. For example, the number of emails exchanged in regard to a topic, the amount of content (e.g., documents, files or attachments) that has been exchanged in relation to the topic, and the number of unique participants in an email thread on the topic are additional heuristics that can change the relevance weight for the Relevance edges 311 that link to that topic.

The data preprocessor 406 then passes (at 607) the parameters or values (that result from these and/or other classification techniques) to a classifier algorithm, such as a Bayes-Classifier or other appropriate classifier function. The classifier algorithm inputs these values and calculates the overall relevance weight or score (e.g., on a scale of 0 to 1) to be assigned to the topic of the event (e.g., of 304-308) using an appropriate classifier technique. For example, in some embodiments, the classifier function assigns a weight to a word by summing all L*F*P*C products for the word for each part of the file/data/document and dividing by the total number of words in the file, data or document for the event; wherein L, F, P and C are values obtained in some of the previous steps of the topic extraction process 600. For example, in some embodiments, L is a location weight (e.g., based on location in a title, a subject line, a body, etc. determined at 603), F is a font or text weight (e.g., indicative of a larger or smaller font size or whether the text is bolded, underlined, italicized or highlighted as determined at 606), P is a part of speech weight (as determined at 604), and C is a count of a number instances that a word with the same L, F and P values occurs within that part of the file/data/document (as determined at 602). In other embodiments, other formulas or algorithms can be used to calculate the overall relevance weight or score. In some embodiments, multiple different formulas or algorithms can be used, and a highest, best, preferred or most reliable value can be selected.

With the overall relevance weight for the relation between the topic and the event, the data preprocessor 406 generates (at 608) the data (described above) for the topic vertex 309 or 310 and the Relevance edges 311 between the topic vertex 309 or 310 and the corresponding event vertex 305-308 (and optionally the other vertices 301-304 to which the corresponding event vertex 305-308 is linked). The data preprocessor 406 transmits (at 609) the topic vertex 309 or 310 and the Relevance edges 311 (with the overall relevance weight) to the database interface system 401 for validation, merging and storage of the data in the graph database 300 in RAM memory and/or in the data storage system 402, as described herein. (In some embodiments, if multiple topics are generated for the same event data, then multiple topic vertices 309 or 310 (with associated Relevance edges 311) are generated and stored.) In this manner, the keyword extraction and analysis generally results in a mapping of the topics (e.g., for the vertices 309 and 310) and their relevance to the vertices 301-308 in the graph database 300.

A client device 404 (typically under control of an entity 102-107) can later send a query to the gateway process 412 with a proposed topic for a meeting or for user data, meeting data for users, user association with topics, meeting rooms for various locations, participant data, etc. The gateway process 412 will use the data in the graph database 300 to fetch the results and return it to the client device 404.

### Meeting Setup

For setting up a meeting, the database interface system 401 is designed to receive a meeting request specifying a proposed meeting topic and the account 111-117 of the meeting organizer. The meeting request is transmitted from the client device 404 associated with the meeting organizer (i.e., a first participant account, e.g., represented by one of the entity ID account vertices 301 and 302) when the meeting organizer enters, selects or submits the proposed meeting topic through a client application with a user interface displayed to the meeting organizer by the client device 404. Alternatively, the meeting request is transmitted from the client device 404 associated with a person acting on behalf of the meeting organizer, in which case the person's client device 404 is considered to be temporarily associated with the meeting organizer.

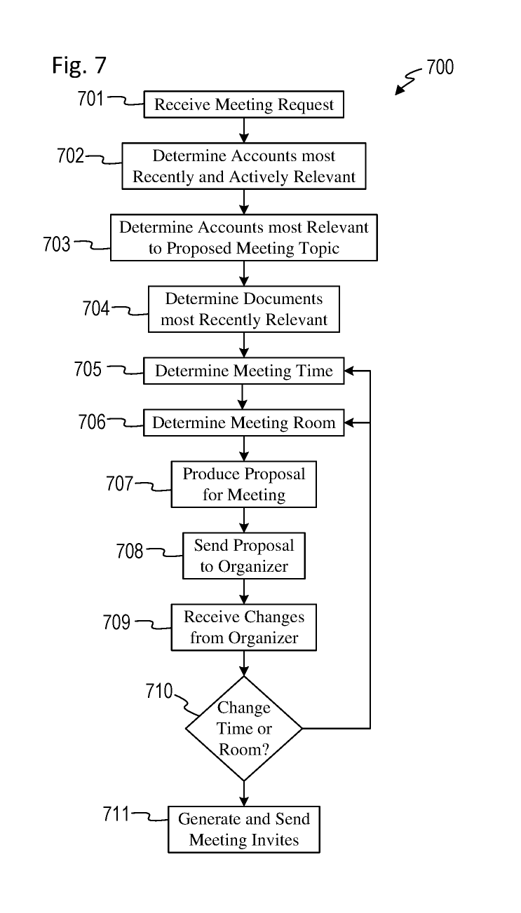

The database interface system 401 resolves the meeting request to a context, i.e., the database interface system 401 (through operations of the gateway process 412 and the core processing engine 413) searches for and returns the potential participants (i.e., one or more second participant accounts, e.g., represented by one or more of the other entity ID account vertices 301 and 302) that are most likely to be interested in or needed for a discussion of the proposed topic, the potential documents or other resources that are most likely to be needed during the discussion, a meeting location, and a meeting time. FIGS. 7-10 show examples of processes for automatically identifying the participants and documents that are most likely to be relevant to the proposed meeting based on the data that has been collected and analyzed as described above.

FIG. 7 shows a simplified flowchart for an example meeting setup process 700 performed by the database interface system 401 (through operations of the gateway process 412 and the core processing engine 413) to provide a proposed meeting (with participants, meeting room, documents and artifacts) to the client devices 404, in accordance with one or more example embodiments. The particular steps, combination of steps, and order of the steps are provided for illustrative purposes only. Other processes with different steps, combinations of steps, or orders of steps can also be used to achieve the same or similar result. Features or functions described for one of the steps performed by one of the components may be enabled in a different step or component in some embodiments.

In some embodiments, the meeting setup process 700 is initiated by the database interface system 401 (e.g., by the gateway process 412) receiving (at 701) a meeting request (with a proposed meeting topic and other requirements) from one of the client devices 404 (e.g., by or on behalf of the meeting organizer, or perspective account) through a data channel. At 702, 703 and 704, the database interface system 401 (e.g., through operations of the gateway process 412 and the core processing engine 413 in cooperation with the graph database 300 in RAM memory or the data storage system 402) determines or identifies 1) the entity ID account vertices 301 and 302 of the accounts 110-117 that have most recently and most actively been involved with the proposed meeting topic, 2) the entity ID account vertices 301 and 302 of the accounts 110-117 that are most relevant to the proposed meeting topic, and 3) the documents (e.g., for the attachment event vertex 307) that have most recently been associated with the proposed meeting topic, respectively. These accounts and documents are, thus, considered to be potentially most relevant to the proposed meeting topic and represent proposed participants and proposed documents. Example processes 800, 900 and 1000 for determining or identifying these accounts and documents are provided below in the descriptions of FIGS. 8-10, respectively. In some embodiments, additional or alternative processes determine or identify potentially relevant accounts or documents in other manners than those described for FIGS. 8-10. In some embodiments, the processes (e.g., 800 and 900) for determining the proposed participants also determine which participants are required and which are optional for the meeting.

In some embodiments, the processes to determine or identify potentially relevant accounts or documents for a proposed meeting generally involve heuristical approaches with fuzzy matching algorithms to predict meeting information or criteria based on the topics. In some embodiments, the processes may first attempt to match the proposed meeting topic with past meetings, since follow-up or recurring meetings are common. Therefore, if there are previous meetings on the same or similar topic, then some of the criteria for the proposed meeting (e.g., participants, meeting room, etc.) can be taken directly from the historical data for the previous meetings. In some embodiments, the processes may attempt to match the proposed meeting topic with an event vertex generated from a subject line of an email. In some embodiments, the processes may attempt to match the proposed meeting topic with topics extracted from the body portion or other file sections of emails for email event vertices. In some embodiments, a match may not be possible, in which case the meeting organizer may be prompted to refine or change the proposed meeting topic. In some embodiments, if the proposed meeting topic potentially matches multiple topics in the graph database 300, then priority may be given to 1) the topic that most closely matches the proposed meeting topic, 2) the topic generated from a more recent event, 3) the topic generated from an email that is part of the largest email thread, or 4) the topic generated from an email that contains more questions, among other criteria.

In some embodiments, with the entity ID account vertices 301 and 302 for the proposed participants, the gateway process 412 determines (at 705) a proposed meeting time. To do so, the gateway process 412 reads the available calendar data for the account vertices 301 and 302 and searches through it to find a mutually available time period, i.e., when all of the participants are available. In some embodiments, if all of the account vertices 301 and 302 use a calendaring application that can determine a mutually available time period, then the gateway process 412 submits the email addresses for the account vertices 301-303 to the calendaring application for the calendaring application to return the mutually available time period. In some embodiments, the meeting request includes a desired duration time period for the meeting, which is taken into consideration when determining the proposed meeting time. In some embodiments, the selection of the proposed meeting time is also based on a variety of considerations related to the importance or influence of some of the participants, such as the availability of the person 1) having the highest importance to the proposed meeting topic, 2) having the highest seniority (or job title or relative position in an org chart), 3) who is the meeting organizer, or 4) who “owns” or manages the project to which the proposed meeting topic pertains, among other considerations, since the time of some participants may be considered more valuable than that of other participants who have to adjust their availability accordingly. In some embodiments, the selection of the proposed meeting time is also based on the relative priorities of different potentially conflicting meetings, such that the gateway process 412 will move a less important meeting to another time slot in order to accommodate a time slot for a more important meeting.

In some embodiments, with the entity ID account vertices 301 and 302 for the proposed participants and the proposed meeting time, the gateway process 412 determines (at 706) a meeting room account vertex (e.g., 303) for a proposed meeting room. To do so, the gateway process 412 reads the data from the entity ID account vertices 301 and 302 and meeting room account vertices (e.g., including 303), such as the vertex properties field, which contains the office locations for the entities 101-107 and the meeting rooms to which the account vertices 301-303 belong, as well as artifacts related to the meeting rooms. The gateway process 412 then compares the locations of the entities with the locations of the meeting rooms, compares the artifacts related to the meeting room with requirements for the meeting (e.g., room capacity compared with the number of proposed participants, presence of projector or other equipment compared to requirements for such items specified in the meeting request, etc.), and selects an appropriate meeting room (e.g., for the meeting room account vertex 303). (In some embodiments, multiple meeting rooms are selected and a conference bridge is specified or reserved for communicating between them, so that some of the proposed participants do not have to travel far.) In some embodiments, the selection or location of the proposed meeting room is also based on a variety of considerations, such as 1) the geographic center of most or all of the meeting participants' locations, 2) the location of the person having the highest importance to the proposed meeting topic, 3) the location of the person having the highest seniority (or job title or relative position in an org chart), 4) the location of the meeting organizer, 5) the location of the person who “owns” or manages the project to which the proposed meeting topic pertains, or 6) the availability of the meeting room artifacts, among other considerations. In some embodiments, the selection of the proposed meeting room is also based on the relative priorities of different potentially conflicting meetings, such that the gateway process 412 will move a less important meeting to another room in order to accommodate a meeting room for a more important meeting. In some embodiments, the office of one or more of the proposed participants can be selected as the meeting room.

In some embodiments, with the entity ID account vertices 301 and 302 for the proposed participants, the attachment event vertices (e.g., 307) for the proposed documents, the meeting room account vertex 303 for the proposed meeting room, and the mutually available time period, the gateway process 412 generates or produces (at 707) a proposal for scheduling the meeting with all of the various criteria and options. To do so, the gateway process 412 reads the identifying data (e.g., proposed participants' names, document titles, and meeting room number) from the vertex properties field for the account vertices 301-303 and the attachment event vertex 307 and formats this data along with the mutually available time period into a file or packet. In some embodiments, the gateway process 412 also takes into consideration various customer extensions, options or company policies related to meetings, e.g., whether to order food for meetings occurring at meal times (e.g., by providing for an email designating meal preferences to be sent to a receptionist or other person responsible for such amenities), whether to provide for beverages (e.g., water, coffee, tea, soft drinks, etc.), whether to select video or audio conferencing between meeting rooms, or whether to notify a participant's secretary or administrative assistant, among other potential considerations. These customer extensions or options can be modifiable or customizable within the meeting setup system 400 by or for each business entity or each individual entity participating in the meeting setup system 400. Additionally, in some embodiments, the gateway process 412 also takes into consideration options for various historical data when generating the proposal for the meeting. For example, information may be setup for, or determined by, the gateway process 412 based on similarity of meeting participants, such that when one particular entity is included as a participant in a meeting, that person's boss or a designated co-worker (which may be dependent on topic) is also included as a participant, or that person's secretary or administrative assistant is also copied on the meeting invite or included as an optional participant. The gateway process 412, thus, includes entries for these options within the generated proposal for the meeting. The gateway process 412 then transmits or sends (at 708) the proposal for the meeting to the client device 404 of the meeting organizer.

In some embodiments, a scheduling application computes a ranked list of best schedules or proposals for the meeting organizer to choose from. The ranking is based on various criteria or parameters, such as the mandatory/required participants, the meeting rooms, the optional participants, and chronology. For example, a first (or relatively high) priority is typically to accommodate as many mandatory participants into the meeting as possible. A next consideration is to accommodate however many meeting rooms are needed at the desired locations. Additionally, the need for meeting room artifacts is another specific criterion for computing a ranked list of schedules. Next, it is desirable to be able to accommodate as many optional participants as possible. Furthermore, the “chronology” parameter prioritizes time slots based on immediacy, so that the sooner time slots are prioritized higher than later time slots.

Additionally, the participants' time zones, work hours and preferences are taken into consideration when possible. For meetings with participants spanning continents, for example, it may be very difficult, if not impossible, to find time slots during everyone's work hours. In that case, the time zone and work hour preferences of the geographical area where the majority of the participants (or of the most senior or highest ranked participant) are located is used to select meeting time slots.

The meeting organizer then has an opportunity to review the proposal for the meeting and make any desired changes to the criteria through a user interface on the client device 404. For example, the ranked list is generally presented to the meeting organizer in order to select the best one. Additionally, the meeting organizer may override some of the recommendations or options for the proposal for the meeting, e.g., deselect or remove some of the proposed participants or proposed documents from the proposal for the meeting, add other participants or documents, switch the required/optional designation of a participant, request a different time or meeting room, or change food or beverage selections, among other potential changes. In some embodiments, as the meeting organizer makes these changes, or fine tunes the recommendations, the gateway process 412 records or learns the behavior or preferences of the meeting organizer (e.g., preferences for particular meeting rooms, meeting at certain times of the day, certain types of meeting room artifacts, particular meeting participants, etc.), so that these preferences are taken into consideration when setting up meetings for this meeting organizer in the future. In some embodiments, the meeting organizer is provided with a selection to mark the meeting as closed, so that it cannot be forwarded or modified by any of the proposed participants who will receive the meeting invite. The meeting organizer then transmits the changes back to the gateway process 412, which receives the changes at 709. If the changes require a different meeting time or meeting room, as determined at 710, then the analyzer 414 returns to 705 or 706, respectively, to repeat through 709 with the changed criteria. Otherwise, in accordance with the criteria approved by the meeting organizer, the gateway process 412 generates and sends (at 711) meeting invites to the email addresses of the entity ID account vertices 301 and 302 for the proposed participants and a tentative reservation to the email address of the meeting room account vertex 303 for the proposed meeting room. Responses by the proposed participants for accepting or declining the invite then determine next course of action as necessary.

FIG. 8 shows a simplified flowchart for the example process 800 performed (at 702, above) by the database interface system 401 (e.g., by the gateway process 412 and the core processing engine 413 in cooperation with the graph database 300 in RAM memory or the data storage system 402) to determine how recently and how actively the entity ID account vertices 301 and 302 of the accounts 110-117 have been involved with the proposed meeting topic, in accordance with one or more example embodiments. The particular steps, combination of steps, and order of the steps are provided for illustrative purposes only. Other processes with different steps, combinations of steps, or orders of steps can also be used to achieve the same or similar result. Features or functions described for one of the steps performed by one of the components may be enabled in a different step or component in some embodiments.

In some embodiments, the gateway process 412 receives (at 801) as input values the identifier for the entity ID account vertex 301 or 302 of the meeting organizer, initial participant or perspective account and the proposed meeting topic. The gateway process 412 generates (at 802) a list of keywords or key phrases based on the proposed meeting topic, including each word or phrase of the proposed meeting topic. To do so, the gateway process 412 reads through the text of the proposed meeting topic to search for individual words or phrases and temporarily stores these in RAM memory.

The gateway process 412 retrieves (at 803) the entity ID account vertex 301 or 302 of the perspective account. To do so, the gateway process 412 uses the email address of the perspective account to access the data (e.g., the vertex ID value or vertex UUID value) of the entity ID account vertex 301 or 302 in the graph database 300 through the core processing engine 413.

Using the vertex ID value or vertex UUID value of the entity ID account vertex 301 or 302 as a starting point, the gateway process 412 traverses (at 804) the edges 311 of the graph database 300 from the entity ID account vertex 301 or 302 to the event and event group vertices 304-308 that are linked thereto. To do so, the gateway process 412 reads the data for the edges 311 linked to the entity ID account vertex 301 or 302 and searches for the vertex ID value or vertex UUID value of the event and event group vertices 304-308.

Using the vertex ID value or vertex UUID value of the event and event group vertices 304-308, the gateway process 412 further traverses (at 805) the edges 311 of the graph database 300 from the event and event group vertices 304-308 to the topic vertices 309 and 310. To do so, the gateway process 412 reads the data for the Relevance edges 311 linked to the event and event group vertices 304-308 and searches for the vertex ID value or vertex UUID value of the topic vertices 309 and 310. Additionally, the gateway process 412 uses the vertex ID value or vertex UUID value of the topic vertices 309 and 310 to read the data for the word or phrase that comprises the topic. The gateway process 412 compares these words or phrases with the keywords or key phrases generated (at 802) from the proposed meeting topic. If there is no match, the event or event group vertex 304-308 that led to this topic vertex 309 or 310 is ignored. However, if there is a match, then the topic vertex 309 or 310 is considered relevant, so the gateway process 412 records (at 806) the vertex ID value or vertex UUID value of the event or event group vertex 304-308 that led to this topic vertex 309 or 310 along with the relevance weight from the Relevance edge 311 between the event or event group vertex 304-308 and this topic vertex 309 or 310. The recorded data is the events and event groups that are linked to the perspective account and to relevant topics with their relevance weight.

Using the vertex ID value or vertex UUID value of the recorded event and event group vertices 304-308, the gateway process 412 further traverses (at 807) the edges 311 (e.g., for Organizer, Required Attendee, Optional Attendee, TO, CC, BCC, etc. edges) of the graph database 300 from these event and event group vertices 304-308 to the entity ID account vertices 301 and 302. To do so, the analyzer 414 reads the data for the TO, CC, BCC, etc. edges 311 linked to the event and event group vertices 304-308 and searches for the vertex ID value or vertex UUID value of the entity ID account vertices 301 and 302. These entity ID account vertices 301 and 302 represent the accounts that are linked to the perspective account and are potentially relevant to the proposed meeting topic according to the relevance weight value of the Relevance edge 311 between the event or event group vertex 304-308 and the relevant topic vertex 309 or 310.

The gateway process 412 then determines and assigns (at 808) an event multiplier value to each of the potentially relevant entity ID account vertices 301 and 302. The event multiplier value is indicative of the potential interest or relevance to the proposed meeting topic of the entity 101-107 that owns the email address of the potentially relevant entity ID account vertex 301 or 302. In other words, an entity 101-107 that has been more actively participating in events is considered to be more actively relevant to the proposed meeting topic and will have a higher event multiplier.

For example, if the event or event group vertex 304-308 is a meeting event vertex 308, and the entity 101-107 was the meeting organizer or a required attendee of the meeting, then it is more likely for the entity 101-107 to have a strong interest in or relevance to the topic of that meeting, so a relatively high event multiplier (e.g., with a value of 1 on a scale of 0 to 1) is assigned to the potentially relevant entity ID account vertex 301 or 302. On the other hand, if the entity 101-107 was an optional attendee of the meeting, then it is less likely for the entity 101-107 to have a strong interest in or relevance to the topic of that meeting, so a lower event multiplier (e.g., with a value of 0.9, or other appropriate value less than 1) is assigned to the potentially relevant entity ID account vertex 301 or 302. For an embodiment that only considers the relevance of those entities who participated in previous meetings, a much lower event multiplier (e.g., with a value of 0, or near 0) is assigned to all other potentially relevant entity ID account vertices 301 or 302. On the other hand, for embodiments that also consider the relevance of entities who participated in email events (e.g., for vertex 305 or 306) or email thread events (e.g., for vertex 304) related to the topic, then further processing may assign other event multiplier values. For example, if the event or event group vertex 304-308 is for an email thread, then a modest event multiplier (e.g., with a value of about 0.8, or other appropriate value less than 1) is assigned to the potentially relevant entity ID account vertex 301 or 302, since an email thread can involve many entities 101-107, many of whom may have been relevant to the topic, but actually interested or involved in only very few of the emails. Additionally, if the event or event group vertex 304-308 is for an email, and the entity 101-107 was the sender of the email or was the only recipient, then it is more likely for the entity 101-107 to have a strong interest in or relevance to the topic of that email, so a relatively high event multiplier (e.g., with a value of 1) is assigned to the potentially relevant entity ID account vertex 301 or 302. On the other hand, if the entity 101-107 was one of many “TO” recipients or was a “CC” or “BCC” recipient, then it is less likely for the entity 101-107 to have a strong interest in or relevance to the topic of that email, so a lower event multiplier (e.g., with a value of 0.9, or other appropriate value less than 1) is assigned to the potentially relevant entity ID account vertex 301 or 302. In some embodiments, additional calculations for similar multipliers for other types of events (such as chat sessions, instant messages, wiki pages, blog entries, etc.) are also performed. For example, a chat or instant message event may be considered more important than an email event, due to the immediacy of those types of communications, so a higher multiplier value may be assigned for these types of events. Additionally, an author of a wiki page or blog entry event may be considered a more important potential meeting stake holder, so a higher multiplier value may be assigned for these types of events.

To determine and assign the event multiplier value, therefore, the gateway process 412 reads the edge label field of the edge 311 that links the potentially relevant entity ID account vertex 301 or 302 to the recorded event or event group vertex 304-308 to determine the type of the edge 311. The gateway process 412 then looks up and stores the appropriate event multiplier value for that edge type.

The gateway process 412 then determines and assigns (at 809) a decay multiplier value to each of the potentially relevant entity ID account vertices 301 and 302. The decay multiplier value is indicative of the age of the recorded event or event group vertex 304-308, so that a newer event will have a greater relevance weight than an older event will have, and an entity 101-107 that has been participating in events more recently will be considered to be more recently relevant to the topic and will have a higher decay multiplier. Thus, the decay multiplier decreases over time, e.g., by a predetermined decrement amount for every predetermined time interval. The time interval may be hours, days, weeks, months, or whatever interval is considered appropriate. If a new event, for example, has an initial decay multiplier value of 1 (on a scale of 0 to 1), then an older event is assigned a decay multiplier value of 1 minus the decrement amount multiplied by the number of time intervals that have passed. Examples for the decrement amount may be on the order of about 0.03, in a range of about 0.01-0.05, or other value that allows for an appropriate amount of relevance weight reduction over time. To determine and assign the decay multiplier value, therefore, the gateway process 412 reads the vertex properties field of the recorded event or event group vertex 304-308 to determine the date of the event. With the date of the event and the present date, the gateway process 412 calculates the number of time intervals that have passed, multiplies that by the decrement amount, and subtracts the product from the initial decay multiplier value to determine and store the decay multiplier value.

The gateway process 412 then calculates (at 810) a current relevance weight for each entity ID account vertex 301 or 302 by multiplying the previously recorded relevance weight, the event multiplier, and the decay multiplier together. In general, the current relevance weight is indicative of the relevance of the account to the topic, depending on the account's relation to the event and the event's age, so that those accounts that are most recently involved in the most direct way with the proposed meeting topic have the highest current relevance weight. The gateway process 412 then returns or outputs (at 811) the current relevance weight for each entity ID account vertex 301-302 (or a list that ranks the relevant accounts according to their current relevance weight) to the process 700 above at 702.

In some embodiments, additional multiplier values may be applied to the product for the current relevance weight. For example, a personal importance multiplier may be used that is indicative of the importance or rank of the person represented by the entity ID account vertex 301-302, such that a corporate director or officer would have a higher personal importance multiplier than a manager, senior engineer, or junior engineer, with similar differences between each of these and other job positions.

FIG. 9 shows a simplified flowchart for the example process 900 performed (at 703, above) by the database interface system 401 (e.g., by the gateway process 412 and the core processing engine 413 in cooperation with the graph database 300 in RAM memory or the data storage system 402) to determine the entity ID account vertices 301 and 302 of the accounts 110-117 that are most relevant to the proposed meeting topic, in accordance with one or more example embodiments. The particular steps, combination of steps, and order of the steps are provided for illustrative purposes only. Other processes with different steps, combinations of steps, or orders of steps can also be used to achieve the same or similar result. Features or functions described for one of the steps performed by one of the components may be enabled in a different step or component in some embodiments.

In some embodiments, the gateway process 412 receives (at 901) as input values the identifier for the entity ID account vertex 301 or 302 of the meeting organizer, initial participant or perspective account and the proposed meeting topic. The gateway process 412 generates (at 902) a list of keywords or key phrases based on the proposed meeting topic, including each word or phrase of the proposed meeting topic. To do so, the gateway process 412 reads through the text of the proposed meeting topic to search for individual words or phrases and temporarily stores these in RAM memory.

The gateway process 412 retrieves (at 903) the entity ID account vertex 301 or 302 of the perspective account. To do so, the gateway process 412 uses the email address of the perspective account to access the data (e.g., the vertex ID value or vertex UUID value) of the entity ID account vertex 301 or 302 in the graph database 300 through the core processing engine 413.

Using the vertex ID value or vertex UUID value of the entity ID account vertex 301 or 302 as a starting point, the gateway process 412 traverses (at 904) the edges 311 of the graph database 300 from the entity ID account vertex 301 or 302 to the event vertices 305-308 that are linked thereto. To do so, the gateway process 412 reads the data for the edges 311 linked to the entity ID account vertex 301 or 302 and searches for the vertex ID value or vertex UUID value of the event and event group vertices 305-308.

Using the vertex ID value or vertex UUID value of the event and event group vertices 304-308, the gateway process 412 further traverses (at 905) the edges 311 of the graph database 300 from the event and event group vertices 304-308 to the entity ID account vertices 301 and 302 for other accounts, i.e., not the perspective account. To do so, the gateway process 412 reads the data for the Organizer, Required Attendee, Optional Attendee, TO, CC, BCC, etc. edges 311 linked to the event and event group vertices 304-308 and searches for the vertex ID value or vertex UUID value of the other entity ID account vertices 301 and 302.

Using the vertex ID value or vertex UUID value of the other entity ID account vertices 301 and 302, the gateway process 412 further traverses (at 906) the edges 311 of the graph database 300 from the other entity ID account vertices 301 and 302 to the topic vertices 309 and 310. To do so, the gateway process 412 reads the data for the Event edges 311 linked to the other entity ID account vertices 301 and 302 and searches for the vertex ID value or vertex UUID value of the event vertices 305-308. Then the gateway process 412 reads the data for the Relevance edges 311 linked to the event vertices 305-308 and searches for the vertex ID value or vertex UUID value of the topic vertices 309 and 310. Additionally, the gateway process 412 uses the vertex ID value or vertex UUID value of the topic vertices 309 and 310 to read the data for the word or phrase that comprises the topic. The gateway process 412 compares these words or phrases with the keywords or key phrases generated (at 902) from the proposed meeting topic. If there is no match, the other entity ID account vertex 301 or 302 that led to this topic vertex 309 or 310 is ignored. However, if there is a match, then the topic vertex 309 or 310 is considered relevant, so the gateway process 412 records (at 907) the vertex ID value or vertex UUID value of the other entity ID account vertex 301 or 302 that led to this topic vertex 309 or 310 along with the relevance weight from the Relevance edge 311 between the other entity ID account vertex 301 or 302 and this topic vertex 309 or 310. After doing so for all of the other entity ID account vertices 301 and 302, the gateway process 412 will have gathered the subset of all of the entity ID account vertices 301 and 302 that are linked to both the perspective account and the proposed meeting topic. The recorded data is, thus, the accounts (the other entity ID account vertices 301 and 302) that are linked to the perspective account and to relevant topics (the relevant topic vertices 309 and 310) with their relevance weight. In some cases, some of the accounts link in this manner to multiple relevant topics with different relevance weights.

For each of the other entity ID account vertices 301 and 302 that are linked to the perspective account, the gateway process 412 then determines (at 908) the highest relevance weight to one of the relevant topic vertices 309 and 310. In general, the highest such relevance weight is indicative of the relevance of the account to the topic, without regard to how or when the account was originally linked to the topic, i.e., the event that caused the link to the topic, so accounts that may not have been actively involved most recently with, but are nevertheless highly related to, the topic are determined. The gateway process 412 then returns or outputs (at 909) the highest relevance weight for each entity ID account vertex 301-302 (or a list that ranks the relevant accounts according to their current relevance weight) to the process 700 above at 703.

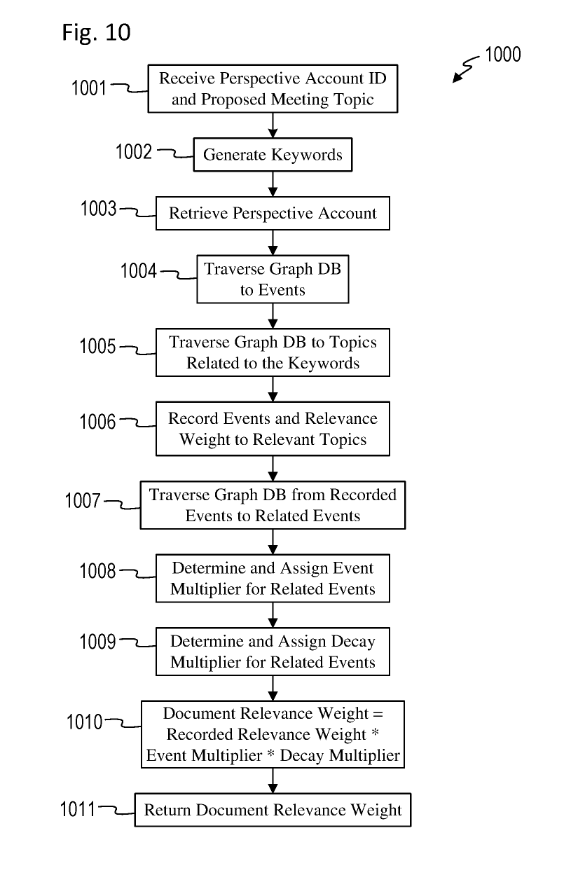

FIG. 10 shows a simplified flowchart for the example process 1000 performed (at 704, above) by the database interface system 401 (e.g., by the gateway process 412 and the core processing engine 413 in cooperation with the graph database 300 in RAM memory or the data storage system 402) to determine the attachment event vertex 307 of the documents that have most recently been involved with the proposed meeting topic, in accordance with one or more example embodiments. The particular steps, combination of steps, and order of the steps are provided for illustrative purposes only. Other processes with different steps, combinations of steps, or orders of steps can also be used to achieve the same or similar result. Features or functions described for one of the steps performed by one of the components may be enabled in a different step or component in some embodiments.

In some embodiments, the gateway process 412 receives (at 1001) as input values the identifier for the entity ID account vertex 301 or 302 of the meeting organizer, initial participant or perspective account and the proposed meeting topic. The gateway process 412 generates (at 1002) a list of keywords or key phrases based on the proposed meeting topic, including each word or phrase of the proposed meeting topic. To do so, the gateway process 412 reads through the text of the proposed meeting topic to search for individual words or phrases and temporarily stores these in RAM memory.

The gateway process 412 retrieves (at 1003) the entity ID account vertex 301 or 302 of the perspective account. To do so, the gateway process 412 uses the email address of the perspective account to access the data (e.g., the vertex ID value or vertex UUID value) of the entity ID account vertex 301 or 302 in the graph database 300.

Using the vertex ID value or vertex UUID value of the entity ID account vertex 301 or 302 as a starting point, the gateway process 412 traverses (at 1004) the edges 311 of the graph database 300 from the entity ID account vertex 301 or 302 to the event vertices 305-308 that are linked thereto. To do so, the gateway process 412 reads the data for the edges 311 linked to the entity ID account vertex 301 or 302 and searches for the vertex ID value or vertex UUID value of the event vertices 305-308.

Using the vertex ID value or vertex UUID value of the event vertices 305-308, the gateway process 412 further traverses (at 1005) the edges 311 of the graph database 300 from the event vertices 305-308 to the topic vertices 309 and 310. To do so, the gateway process 412 reads the data for the Relevance edges 311 linked to the event vertices 305-308 and searches for the vertex ID value or vertex UUID value of the topic vertices 309 and 310. Additionally, the gateway process 412 uses the vertex ID value or vertex UUID value of the topic vertices 309 and 310 to read the data for the word or phrase that comprises the topic. The gateway process 412 compares these words or phrases with the keywords or key phrases generated (at 1002) from the proposed meeting topic. If there is no match, the event vertex 305-308 that led to this topic vertex 309 or 310 is ignored. However, if there is a match, then the topic vertex 309 or 310 is considered relevant, so the gateway process 412 records (at 1006) the vertex ID value or vertex UUID value of the event vertex 305-308 that led to this topic vertex 309 or 310 along with the relevance weight from the Relevance edge 311 between the event vertex 305-308 and this topic vertex 309 or 310. The recorded data is the events that are linked to the perspective account and to relevant topics with their relevance weight.

Using the vertex ID value or vertex UUID value of the recorded event vertices 305-308, the gateway process 412 further traverses (at 1007) the edges 311 of the graph database 300 from the recorded event vertices 305-308 to related event vertices (e.g., the attachment event vertex 307). To do so, the gateway process 412 reads the data for the edges 311 linked to the recorded event vertices 305-308 and searches for the vertex ID value or vertex UUID value of other event vertices. The other event vertices represent other events (e.g., email attachments or documents) that are related to the recorded event vertices 305-308 and are potentially relevant to the proposed meeting topic according to the relevance weight value of the Relevance edge 311 between the recorded event vertex 305-308 and the relevant topic vertex 309 or 310 or according to the relevance weight value of the Relevance edge 311 between the related event vertex and the relevant topic vertex 309 or 310.

The gateway process 412 then determines and assigns (at 1008) an event multiplier value to each related event vertex. The event multiplier value is indicative of the potential relevance of the related event vertex to the proposed meeting topic, assuming the recorded event vertex 305-308 is relevant to the proposed meeting topic. For example, an email attachment that was attached to an email that is relevant to the proposed meeting topic is assumed to also be relevant to the proposed meeting topic, so a higher event multiplier (e.g., a value of 1 on a scale of 0 to 1) is assigned to the potentially relevant related event vertex. On the other hand, if the related event vertex is not an email attachment, a lower event multiplier (e.g., a value of 0) is assigned to the potentially relevant related event vertex.

To determine and assign the event multiplier value, therefore, the gateway process 412 reads the edge label field of the edge 311 that links the potentially relevant related event vertex to the recorded event vertex 305-308 or the vertex label field of the potentially relevant related event vertex to determine if the potentially relevant related event vertex is an email attachment. If so, then the gateway process 412 stores an event multiplier value of 1 for the related event vertex. If not, then the gateway process 412 stores an event multiplier value of 0 for the related event vertex.

The gateway process 412 then determines and assigns (at 1009) a decay multiplier value to each potentially relevant related event vertex. The decay multiplier value is indicative of the age of the recorded event vertex 305-308 or of the related event vertex, so that a newer related event will have a higher decay multiplier than an older related event will have. Thus, the decay multiplier decreases over time, e.g., by a predetermined decrement amount for every predetermined time interval. The time interval may be hours, days, weeks, months, or whatever interval is considered appropriate. If a new related event, for example, has an initial decay multiplier value of 1 (on a scale of 0 to 1), then an older related event is assigned a decay multiplier value of 1 minus the decrement amount multiplied by the number of time intervals that have passed. Examples for the decrement amount may be on the order of about 0.03, in a range of about 0.01-0.05, or other value that allows for an appropriate amount of relevance weight reduction over time. To determine and assign the decay multiplier value, therefore, the gateway process 412 reads the vertex properties field of the recorded event vertex 305-308 or of the related event vertex to determine the date of the recorded event or the related event. With this date and the present date, the gateway process 412 calculates the number of time intervals that have passed, multiplies that by the decrement amount, and subtracts the product from the initial decay multiplier value to determine and store the decay multiplier value.

The gateway process 412 then calculates (at 1010) a document relevance weight for each related event vertex by multiplying the previously recorded relevance weight, the event multiplier, and the decay multiplier together. In general, the document relevance weight is indicative of the relevance of the related event to the topic, depending on the related event's relation to the recorded event and the related or recorded event's age, so that those related events (e.g., email attachment documents) that are most recently involved with the proposed meeting topic have the highest document relevance weight. The gateway process 412 then returns or outputs (at 1011) the document relevance weight for each related event vertex (or a list that ranks the relevant related event vertices according to their document relevance weight) to the process 700 above at 704.

In some embodiments, additional or alternative processes are used to determine or identify potentially relevant accounts or documents in other manners than those described for FIGS. 8-10. For example, the processes 800, 900 and 1000 return accounts and documents that have already been linked to the account of the meeting organizer due to the occurrence of an event, so another account or document identifying process could identify the entity ID account vertices 301 and 302 of the accounts 110-117, or the attachment event vertex 307 of the documents, that are most relevant to the proposed meeting topic regardless of whether any of these accounts or documents have an existing link to the account of the meeting organizer. Additionally, in some embodiments, the processes 800, 900 and 1000 are combined, such that similar steps are performed only once.

### Meeting Anticipation

In some embodiments, the meeting setup system 400 (e.g., through operations of the gateway process 412 and the core processing engine 413 in cooperation with the graph database 300 in RAM memory or the data storage system 402) enables a meeting setup prompt to be provided to an entity 102-107 when the meeting setup system 400 determines that a conversation could benefit from a meeting. In other words, the meeting setup system 400 can anticipate a need for a meeting before any of the entities 102-107 submits a meeting request. For example, an email or other mode of conversation could present an inline option (e.g., a “meeting setup” button screen icon) to setup a meeting when a heuristic has been reached. If the entity 102-107 accepts the option or prompt, then the process to generate a proposal for a meeting proceeds as described above for situations in which the entity 102-107 submits a meeting request.

One heuristic for determining when to generate a “setup meeting” prompt may be the number of emails or messages in an email thread or other type of discussion, so that after a threshold number of emails have been exchanged in an email thread, then the meeting setup system 400 will ask one or more of the entities 102-107 involved whether they want to have a meeting, since a meeting may be able to bring the conversation to closure more quickly than continuing to exchange more emails could. Another heuristic may be the number of participants (e.g., in an email thread), so that if a threshold number of participants have been included in a conversation, then the meeting setup system 400 will ask one or more of the entities 102-107 involved whether they want to have a meeting, since it can be easier to coordinate a large number of participants via a meeting than via emails. Another heuristic may be the amount of content that is exchanged between the participants of the conversation, so that if a threshold number of documents have been exchanged, then the meeting setup system 400 will ask one or more of the entities 102-107 involved whether they want to have a meeting, since a large number of documents passing back and forth can result in confusion over which is the current version, and a meeting could clear this up. Another heuristic may be the number of questions that are asked in the conversation, so that if a threshold number of questions is detected, then the meeting setup system 400 will ask one or more of the entities 102-107 involved whether they want to have a meeting, since a large number of questions can be difficult to answer in a written conversation, but easy to answer in a meeting. Another heuristic may be the apparent tone of the conversation, so that if an analysis of the text of the conversation detects a threshold number of negative words or phrases, then the meeting setup system 400 will ask one or more of the entities 102-107 involved whether they want to have a meeting, since problems or hurt feelings can be ironed out better by a meeting than by continued emails. Another heuristic may include the number of unique participants in an email thread or the number of people copied in the email thread (because when more people participate in the email thread, it is assumed that there are more stakeholders in the topic, and there is a greater need for a meeting). Another heuristic may include the number of certain keywords or phrases used during the scope of the discussion (e.g., “needs more thought,” “not as simple,” “worth discussing,” “another possibility,” or other words or phrases indicating a need for a resolution of an issue or an opportunity to move the issue forward).

### Schematic

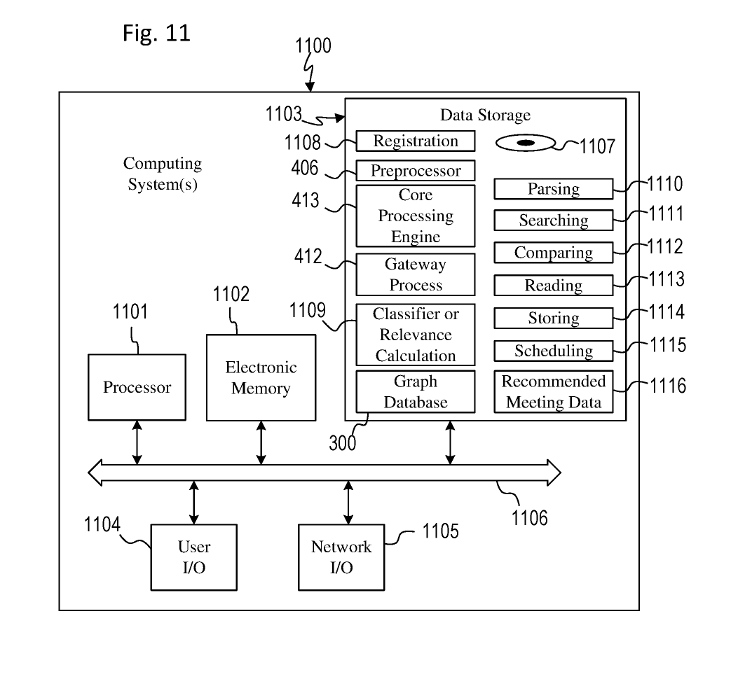

A simplified schematic diagram showing an example computing system(s) 1100 for use in the meeting setup system 400 is shown in FIG. 11, in accordance with some embodiments. Other embodiments may use other components and combinations of components. For example, the computing system may represent one or more physical computer devices, such as web servers, rack-mounted computers, network storage devices, desktop computers, laptop/notebook computers, etc. In some embodiments implemented at least partially in a cloud network potentially with data synchronized across multiple geolocations, the computing system 1100 may be referred to as a cloud server. In some embodiments, the functions of the computing system 1100 are enabled in a single computer device. In more complex implementations, some of the functions of the computing system 1100 are distributed across multiple computer devices, whether within a single server farm facility or multiple physical locations. In some embodiments wherein the computing system 1100 represents multiple computer devices, some of the functions of the computing device 1100 are implemented in some of the computer devices, while other functions are implemented in other computer devices. In the illustrated embodiment, the computing system 1100 generally includes at least one processor 1101, a main electronic memory 1102, a data storage 1103, a user I/O 1104, and a network I/O 1105, among other components not shown for simplicity, connected or coupled together by a data communication subsystem 1106.

The processor 1101 represents one or more central processing units on one or more PCBs in one or more housings or enclosures. In some embodiments, the processor 1101 represents multiple microprocessor units in multiple computer devices at multiple physical locations interconnected by one or more data channels, such as the Internet, a WAN, a LAN, etc. When executing computer-executable instructions for performing the above described functions of the meeting setup system 400 in cooperation with the main electronic memory 1102, the processor 1101 becomes a special purpose computer for performing the functions of the instructions.

The main electronic memory 1102 represents one or more RAM modules on one or more PCBs in one or more housings or enclosures. In some embodiments, the main electronic memory 1102 represents multiple memory module units in multiple computer devices at multiple physical locations. In operation with the processor 1101, the main electronic memory 1102 stores the computer-executable instructions executed by, and data processed by, the processor 1101 to perform the above described functions of the meeting setup system 400.

The data storage 1103 represents or comprises any appropriate number or combination of internal or external physical mass storage devices, such as hard drives, optical drives, network-attached storage (NAS) devices, flash drives, etc. In some embodiments, the data storage 1103 represents multiple mass storage devices in multiple computer devices at multiple physical locations. The data storage 1103 generally provides persistent storage (e.g., in a non-transitory computer readable medium 1107) for the programs (e.g., computer-executable instructions) and data used in operation of the processor 1101 and the main electronic memory 1102, such as, but not limited to, a registration unit 1108 for performing the registration of the entities 102-107 and the receipt of the user credentials described above, the data preprocessor 406 described above, the core processing engine 413 described above, the gateway process 412 described above, a classifier or relevance calculation unit 1109 for performing the classifier functions described above, a parsing routine 1110 for parsing data as mentioned above, a searching routine 1111 for searching through data for desired data as mentioned above, a comparing routine 1112 for comparing different data to find a match as mentioned above, a reading routine 1113 for reading data from the RAM memory or the data storage system 402 as mentioned above, a storing routine 1114 for storing data in the RAM memory or the data storage system 402 as mentioned above, a scheduling application 1115 for performing the scheduling functions described above, a recommended meeting data 1116 comprising the schedules or proposals for meetings described above, and the graph database 300 described above, among others. Under control of these programs and using this data, the processor 1101, in cooperation with the main electronic memory 1102, performs the above described functions for the meeting setup system 400.

The user I/O 1104 represents one or more appropriate user interface devices, such as keyboards, pointing devices, displays, etc. In some embodiments, the user I/O 1104 represents multiple user interface devices for multiple computer devices at multiple physical locations. A system administrator, for example, may use these devices to access, setup and control the computing system 1100.

The network I/O 1105 represents any appropriate networking devices, such as network adapters, etc. for communicating through a network, such as the Internet, a WAN, a LAN, etc. In some embodiments, the network I/O 1105 represents multiple such networking devices for multiple computer devices at multiple physical locations for communicating through multiple data channels. The client devices 404 must communicate with the computing system 1100 through the network I/O 1105 to submit meeting requests and respond to the proposed schedules to setup the meetings. The data source services 403 must communicate with the computing system 1100 through the network I/O 1105 to provide the various types of data used by the meeting setup system 400 relating to email, chat, SMS text messaging, social networking, phone, voicemail, calendars, blogs, web sites, wiki pages, etc. Additionally, the various computer devices that comprise the computing system 1100 must communicate with each other through the network I/O 1105 to perform the above described functions of the meeting setup system 400.

The data communication subsystem 1106 represents any appropriate communication hardware for connecting the other components in a single unit or in a distributed manner on one or more PCBs, within one or more housings or enclosures, within one or more rack assemblies, etc.

### CONCLUSION

The meeting setup system 400 described above is an improvement in the technology and technical field of electronically setting up a meeting, since the meeting setup system 400 provides a meeting organizer with a convenient technique of simply submitting a proposed meeting topic and causing the computing system 1100 to generate one or more proposed schedules for meetings that would satisfy the needs of the topic. Additionally, the meeting setup system 400 described above is an improvement in the technology and technical field of electronic communications, since the meeting setup system 400 streamlines and speeds up the ability to communicate between entities to potentially reach closure on issues regarding topics of mutual concern. Furthermore, the meeting setup system 400 described above is an improvement in the technology and technical field of database formation and maintenance, since the meeting setup system 400 enables collection, extraction and structuring of data that was heretofore not maintained according to the types of relations described herein. In addition, the meeting setup system 400 described above improves the performance of the computing system 1100, since the speed with which the computing system 1100 can setup a meeting is greatly enhanced and the need for human intervention is reduced. The meeting setup system 400 described above also addresses the Internet-centric challenge of coordinating among different entities to enhance communication, electronically setup meetings, and collect electronic information from disparate data sources across the Internet. Additionally, the meeting setup system 400 described above does not preempt the field of electronically setting up meetings, because many other techniques for meeting setup are readily available; whereas the technique described herein is simply directed to the improvements thus enabled. Furthermore, it is noted that the meeting setup technique makes sense only in the context of a computing system, since significant portions of the technique involve complex traversal of highly complicated data interrelations with calculations and functions that a person would not need or be able to perform.

One or more aspects or features of the subject matter described herein can be realized in digital electronic circuitry, integrated circuitry, specially designed application specific integrated circuits (ASICs), field programmable gate arrays (FPGAs), computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or an assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a machine-readable medium. The machine-readable medium can store such machine instructions non-transitorily, such as for example as would a non-transient solid-state memory or a magnetic hard drive or any similar storage medium. The machine-readable medium can alternatively or additionally store such machine instructions in a semi-transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor, for displaying information to the user and a keyboard and a pointing device, such as for example a mouse, a touchpad or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one” or “one or more” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method comprising:
receiving, by one or more computers through one or more data channels from a first client device associated with a first participant account, a meeting request that specifies the first participant account and a proposed topic for a meeting;
determining, by the one or more computers reading and traversing a database in a data storage system, one or more second participant accounts for the meeting that are linked to the proposed topic in the database; and
scheduling, by the one or more computers, the meeting with the first participant account and the one or more second participant accounts by transmitting meeting invites through the one or more data channels to the first client device and one or more second client devices associated with the one or more second participant accounts;
and wherein:
the database contains data for a plurality of accounts associated with entities, a plurality of events involving the entities, a plurality of prior topics derived from the events, and a plurality of links between the accounts, events and prior topics; and
the meeting request activates the reading and traversing of the database by the one or more computers to determine the one or more second participant accounts;
and wherein the plurality of accounts includes the first participant account and the one or more second participant account.

2. The method of claim 1, wherein:
the database is a graph database having account vertices for the plurality of accounts, event vertices for the plurality of events, topic vertices for the plurality of prior topics, topic edges linking the topic vertices to the event vertices, and non-topic edges linking the account vertices to the event vertices;
the reading and traversing of the database further comprises reading a first account vertex for the first participant account, traversing from the first account vertex through a first non-topic edge to a first event vertex, traversing from the first event vertex through a first topic edge to a first topic vertex, and traversing from the first event vertex through a second non-topic edge to a second account vertex for a first one of the one or more second participant accounts; and
the method further comprises determining, by the one or more computers, whether the first one of the one or more second participant accounts is linked to the proposed topic by comparing a first prior topic of the first topic vertex to the proposed topic.

3. The method of claim 1, further comprising:
determining, by the one or more computers reading and traversing the database in the data storage system, a relevance of a subset of the plurality of accounts to the proposed topic;
and wherein the determining of the one or more second participant accounts further comprises selecting, by the one or more computers, the one or more second participant accounts from the subset of the plurality of accounts.

4. The method of claim 3, further comprising:
determining, by the one or more computers reading and traversing the database in the data storage system, a rank of the relevance of the accounts in the subset of the plurality of accounts to the proposed topic;
and wherein the determining of the one or more second participant accounts further comprises selecting, by the one or more computers, the one or more second participant accounts from the subset of the plurality of accounts in accordance with their rank.

5. The method of claim 4, wherein:
the determining of the rank further comprises determining how recently and how actively the accounts in the subset of the plurality of accounts have been involved with the proposed topic.

6. The method of claim 1, further comprising:
determining, by the one or more computers reading and traversing the database in the data storage system, one or more documents for the meeting that are linked to the proposed topic in the database.

7. The method of claim 1, further comprising:
prior to transmitting meeting invites, transmitting, by the one or more computers, a proposed schedule for the meeting to the first client device for presentation to a meeting organizer to approve or change the proposed schedule.

8. The method of claim 1, further comprising:
collecting, by the one or more computers, prior email data and prior meeting data; and
forming, by the one or more computers, the database in the data storage system from the prior email data and the prior meeting data.

9. The method of claim 8, wherein the forming of the database further comprises:
extracting the prior topics from the prior email data and the prior meeting data.

10. A computing system, comprising:
one or more processors; and
electronic memory that comprises computer-executable instructions that, when executed by the one or more processors, cause the at one or more processors to perform acts including:
receiving, by the one or more processors through one or more data channels from a first client device associated with a first participant account, a meeting request that specifies the first participant account and a proposed topic for a meeting;
determining, by the one or more processors reading and traversing a database in a data storage system, one or more second participant accounts for the meeting that are linked to the proposed topic in the database; and
scheduling, by the one or more processors, the meeting with the first participant account and the one or more second participant accounts by transmitting meeting invites through the one or more data channels to the first client device and one or more second client devices associated with the one or more second participant accounts;
and wherein:
the database contains data for a plurality of accounts associated with entities, a plurality of events involving the entities, a plurality of prior topics derived from the events, and a plurality of links between the accounts, events and prior topics; and
the meeting request activates the reading and traversing of the database by the one or more processors to determine the one or more second participant accounts;
and wherein the plurality of accounts includes the first participant account and the one or more second participant account.

11. The computing system of claim 10, wherein:
the database is a graph database having account vertices for the plurality of accounts, event vertices for the plurality of events, topic vertices for the plurality of prior topics, topic edges linking the topic vertices to the event vertices, and non-topic edges linking the account vertices to the event vertices;
the reading and traversing of the database further comprises reading a first account vertex for the first participant account, traversing from the first account vertex through a first non-topic edge to a first event vertex, traversing from the first event vertex through a first topic edge to a first topic vertex, and traversing from the first event vertex through a second non-topic edge to a second account vertex for a first one of the one or more second participant accounts; and
the memory further comprises computer-executable instructions that, when executed by the at least one processor, cause the at least one processor to perform acts including: determining, by the one or more processors, whether the first one of the one or more second participant accounts is linked to the proposed topic by comparing a first prior topic of the first topic vertex to the proposed topic.

12. The computing system of claim 10, the memory further comprising computer-executable instructions that, when executed by the at least one processor, cause the at least one processor to perform acts including:
determining, by the one or more processors reading and traversing the database in the data storage system, a relevance of a subset of the plurality of accounts to the proposed topic;
and wherein the determining of the one or more second participant accounts further comprises selecting, by the one or more processors, the one or more second participant accounts from the subset of the plurality of accounts.

13. The computing system of claim 12, the memory further comprising computer-executable instructions that, when executed by the at least one processor, cause the at least one processor to perform acts including:
determining, by the one or more processors reading and traversing the database in the data storage system, a rank of the relevance of the accounts in the subset of the plurality of accounts to the proposed topic;
and wherein the determining of the one or more second participant accounts further comprises selecting, by the one or more processors, the one or more second participant accounts from the subset of the plurality of accounts in accordance with their rank.

14. The computing system of claim 13, wherein:
the determining of the rank further comprises determining how recently and how actively the accounts in the subset of the plurality of accounts have been involved with the proposed topic.

15. The computing system of claim 10, the memory further comprising computer-executable instructions that, when executed by the at least one processor, cause the at least one processor to perform acts including:
determining, by the one or more processors reading and traversing the database in the data storage system, one or more documents for the meeting that are linked to the proposed topic in the database.

16. The computing system of claim 10, the memory further comprising computer-executable instructions that, when executed by the at least one processor, cause the at least one processor to perform acts including:
prior to transmitting meeting invites, transmitting, by the one or more processors, a proposed schedule for the meeting to the first client device for presentation to a meeting organizer to approve or change the proposed schedule.

17. The computing system of claim 10, the memory further comprising computer-executable instructions that, when executed by the at least one processor, cause the at least one processor to perform acts including:
collecting, by the one or more processors, prior email data and prior meeting data; and
forming, by the one or more processors, the database in the data storage system from the prior email data and the prior meeting data.

18. The computing system of claim 17, wherein the forming of the database further comprises:
extracting the prior topics from the prior email data and the prior meeting data.

19. A non-transitory computer-readable medium comprising instructions stored thereon that, when executed on one or more computers, perform the steps of:
receiving, by the one or more computers through one or more data channels from a first client device associated with a first participant account, a meeting request that specifies the first participant account and a proposed topic for a meeting;
determining, by the one or more computers reading and traversing a database in a data storage system, one or more second participant accounts for the meeting that are linked to the proposed topic in the database; and
scheduling, by the one or more computers, the meeting with the first participant account and the one or more second participant accounts by transmitting meeting invites through the one or more data channels to the first client device and one or more second client devices associated with the one or more second participant accounts;
and wherein:
the database contains data for a plurality of accounts associated with entities, a plurality of events involving the entities, a plurality of prior topics derived from the events, and a plurality of links between the accounts, events and prior topics; and
the meeting request activates the reading and traversing of the database by the one or more computers to determine the one or more second participant accounts;
and wherein the plurality of accounts includes the first participant account and the one or more second participant account.

20. The non-transitory computer-readable medium of claim 19, wherein:
the database is a graph database having account vertices for the plurality of accounts, event vertices for the plurality of events, topic vertices for the plurality of prior topics, topic edges linking the topic vertices to the event vertices, and non-topic edges linking the account vertices to the event vertices;
the reading and traversing of the database further comprises reading a first account vertex for the first participant account, traversing from the first account vertex through a first non-topic edge to a first event vertex, traversing from the first event vertex through a first topic edge to a first topic vertex, and traversing from the first event vertex through a second non-topic edge to a second account vertex for a first one of the one or more second participant accounts; and
the instructions further comprise instructions, that when executed on the one or more computers, perform the steps of: determining, by the one or more computers, whether the first one of the one or more second participant accounts is linked to the proposed topic by comparing a first prior topic of the first topic vertex to the proposed topic.
